(19) United States
(12) Patent Application Publication
(10) Pub. No.: US 2008/0078455 A1
(43) Pub. Date: Apr. 3, 2008

(54) Compact Manifolded Fail Safe Hydraulic Control System

(76) Inventor: Andrew John Patterson, Edmonton (CA)

Correspondence Address: GABLE & GOTWALS, 100 WEST FIFTH STREET, 10TH FLOOR, TULSA, OK, 74103, US

(21) Appl. No.: 11/931,364

(22) Filed: Oct. 31, 2007

Related U.S. Application Data
(63) Continuation-in-part of application No. 11/601,222, filed on Nov. 17, 2006.

(30) Foreign Application Priority Data
Nov. 18, 2005 (CA) 2,535,326

(51) Int. Cl. F16K 31/124

(52) U.S. Cl. 137/458

(57) ABSTRACT

A manifolded fail-safe hydraulic control system provides fail-safe operation of a pipeline valve using no more than a total of 43 proprietary parts in the system. The system controls the operation of a spring return actuator, which in turn strokes the pipeline valve from the normal operating position to the fail-safe position, or from the fail-safe position to the normal operating position. The system enables the valve to automatically stroke to its fail-safe position without external power.

### CROSS-REFERENCE TO PRIOR APPLICATIONS

This application is a continuation-in-part patent application claiming priority to U.S. patent application Ser. No. 11/601,222, filed Nov. 17, 2006, and entitled, “Compact Manifolded Fail Safe Hydraulic Control System,” which claimed priority to Canadian Patent Application No. 2,535,326, filed Nov. 18, 2005, and entitled, “Compact Manifolded Fail Safe Hydraulic Control System.”

### 1. FIELD OF THE INVENTION

This invention relates to the automation of pipeline valves used in critical fail-open or fail-close applications.

### 2. BACKGROUND OF THE INVENTION

Self-contained emergency shut down systems, designed to control the emergency shut down closure of valves on oil and gas wellheads, contain a significantly large number of proprietary components. The large, total number of proprietary components used in these systems leads to unreliability. A need exists, therefore, for a self-contained emergency shut down system that contains fewer components and provides for a greater level of emergency shut down reliability and performance.

### BRIEF SUMMARY OF THE INVENTION

A self-contained, emergency shut down system according to this invention provides an incremental improvement in reliability due to its simple design configuration. It is ideal for controlling critical fail-open and fail-close pipeline valves. Critical applications require that the pipeline valve does stroke to the fail-safe position without the need for an external power source. Fail-open applications include fire protection, pressure relief, and process balance. Providing six possible hand pump handle positions provides a level of ergonomics which is not currently being sold. Incorporating a compact oil immersed hydraulic power pack within a reservoir provides an incremental improvement in operating convenience and application flexibility.

The simple and compact manifolded fail safe hydraulic control system (CFHCS) represents a new and useful improvement to the typical hydraulic emergency shutdown systems currently available. Its superior reliability, application flexibility, and compact size make it ideal for critical applications other than oil and gas wellheads. Instead of the typical arrangement where each control device is assembled in its own pressurized body, control devices are assembled into one single pressurized manifold. The total number of proprietary parts compared to existing emergency shutdown systems is minimized to increase reliability.

The CFHCS comprises a pump, a pressure regulator, a low pressure volume accumulator, a low pressure relief valve, a high pressure relief valve, a piloted 2-way dump valve, a reservoir, and a single manifold. A 3-way high and low pressure pilot monitors pipeline pressure and conditions the monitored pipeline parameter signal and delivers or removes the pilot pressure acting on the piloted 2-way dump valve. The CFHCS may also include an optional 3-way electric solenoid valve.

The manifold contains passageways capable of allowing fluid flow within the passageways, and the pump, low pressure volume accumulator, pressure regulator; low pressure relief valve, high pressure relief valve, and piloted 2-way dump valve are contained within the single manifold and the reservoir and connected to the passageways. The 3-way high and low pressure pilot and optional 3-way electric solenoid valve are not contained within the manifold. The outer perimeter of the reservoir is fully contained within the outer perimeter of the manifold. The manifold may be configured for switching low pressure or high pressure, for switching low pressure only, or for switching high pressure only.

The pump may be a hand pump or an oil immersed electric pump that is containable within the reservoir. The manifold may be configured to accommodate each type of pump. The hand pump comprises a handle and a piston. The handle provides six indexed operating positions and 150° of adjustment in a vertical plane of the hand pump. The piston is contained within the manifold and being connectable to said passageways in said manifold. The hand pump further comprises a module that contains a check valve and pump discharge filter. The module is connected to the manifold and provides access to the check valve and pump discharge filter without affecting containment of the piston in the manifold.

The piloted 2-way dump valve comprises a cover, a lift, a piston, a piston spring load, a sleeve, and a plunger. The lift and plunger are threaded together and fasten the piston in between. The piloted 2-way dump valve further comprises a lever having a lever spring load and a lever guide. The lever guide is configured to prevent the lever from moving into a position that could render the CFHCS ineffective.

When configured for switching high pressure, the piloted 2-way dump valve further comprises a high pressure seat and a seat spring load. Additionally, the sleeve is a high pressure sleeve and threaded. The plunger is a high pressure plunger and has an enlarged tapered end.

When configured for switching low pressure, the piloted 2-way dump valve further comprises a retaining ring and the sleeve is a low pressure sleeve that has a plurality of inner and outer annular cavities, cross-drilled to create radially spaced fluid flow passages. The plunger is a low pressure plunger and has a plurality of seals located on its outside diameter spaced axially in relation to the radially spaced fluid flow passages of the low pressure sleeve.

The pressure regulator comprises a cover, a piston, a spring plate, a piston spring load, a high pressure poppet, and a high pressure poppet spring load. The piston is oriented to cycle in a vertical plane of the manifold. The poppet is oriented to provide a high pressure seat surface against the manifold. The low pressure volume accumulator further comprises a cover, a piston, and a piston spring load. The piston has an extended spring guide diameter. The piston also has at least one spiral groove across its face.

The low pressure relief valve comprises a cap, a poppet, a seat, and a poppet spring load. The poppet is oriented to cycle in a vertical plane of the manifold and the seat is oriented to form a soft seal. The high pressure relief valve shares the cap of the low pressure relief valve and further comprises a poppet, a seat, and a poppet spring load. The poppet is oriented to cycle in a vertical plane of the manifold and the seat is oriented to form a soft seal.

The 3-way high and low pressure pilot body is threaded into the pipeline and comprises a sleeve and a retaining ring for positioning the sleeve against a surface of the manifold. The sleeve has a plurality of inner and outer annular cavities that have cross-drilled radially spaced fluid flow passages. The sleeve further comprises a spool that has a plurality of outer soft seals. The outer soft seals are specifically spaced axially in relation to the radially spaced fluid flow passages in the sleeve. The 3-way high and low pressure pilot may further comprise a low spring saddle, a low spring plate, a high spring saddle, a spring nut, a low spring load, and a high spring load. The spring nut has a hole through which the high spring saddle moves axially. The high spring saddle is oriented to encompass and limit compression of the low spring at a high pipeline pressure and the de-compression of the high spring at low pipeline pressure.

The CFHCS according to this invention also embodies a method of hydraulic control of a pipeline valve comprising the steps of holding hydraulic fluid pressure in an actuator hydraulic cylinder that maintains a valve in its normal operating position and venting hydraulic fluid pressure from the actuator hydraulic cylinder in order to allow the valve to move into its fail-safe position. The venting step may further include the steps of removing the monitored pipeline parameter signal to the piloted two-way dump valve and releasing the spring load on a piston of the piloted two-way dump valve so that the piloted two-way dump valve is in its open position. The holding step may further include the steps of positioning a lever of a piloted two-way dump valve under spring load so that the piloted two-way dump valve is in its closed position, conditioning a monitored pipeline parameter signal to the piloted two-way dump valve; and activating the lever to swing vertically downward to indicate when the pipeline valve is correctly reset. The conditioning step may further include the steps of placing a pressure-responsive spool inside a sleeve of a 3-way high and low pressure pilot so that the spool is free to move axially within the sleeve based on a monitored pipeline parameter signal, limiting the lower axial movement of the spool within the sleeve based on a low pipeline parameter signal, limiting the higher axial movement of the spool within the sleeve based on a high pipeline parameter signal, setting seal positions within the sleeve for holding hydraulic fluid pressure at a normal pipeline parameter signal; and setting seal positions within the sleeve for venting hydraulic fluid pressure at a high or a low pipeline parameter signal.

### BRIEF DESCRIPTION OF THE DRAWINGS

Preferred embodiments of the invention will now be described in further detail. Other features, aspects, and advantages of the present invention will become better understood with regard to the following detailed description, appended claims, and accompanying drawings (which are not to scale) where:

FIGS. 1 to 2B provide schematic drawings of different embodiments of the compact manifolded fail safe hydraulic control system (CFHCS).

FIG. 1 is a schematic drawing of the CFHCS with a piloted 2-way dump valve configured to switch low pressure to control the operation of a typical fail-safe pipeline valve.

FIG. 1A is a schematic drawing of the CFHCS with the piloted 2-way dump valve switching low signal pressure thereby controlling a linear valve and high pressure spring return actuator.

FIG. 1B is a schematic drawing of the CFHCS with the piloted 2-way dump valve switching low signal pressure thereby controlling a quarter-turn valve and high pressure spring return actuator.

FIG. 1C is a schematic drawing of the CFHCS with the piloted 2-way dump valve switching low cylinder pressure thereby controlling a linear valve and low pressure spring return actuator.

FIG. 1D is a schematic drawing of the CFHCS with the piloted 2-way dump valve switching low cylinder pressure thereby controlling a quarter-turn valve and low pressure spring return actuator.

FIG. 1E is a schematic drawing of the CFHCS with the piloted 2-way dump valve switching high cylinder pressure thereby controlling a linear valve and high pressure spring return actuator.

FIG. 1F is a schematic drawing of the CFHCS with the piloted 2-way dump valve switching high cylinder pressure thereby controlling a quarter-turn valve and high pressure spring return actuator.

FIG. 2 is a schematic drawing of the CFHCS with a piloted 2-way dump valve configured to switch high pressure to control the operation of a typical fail-safe pipeline valve.

FIG. 2A is a schematic drawing of the CFHCS with an electric pump and the piloted 2-way dump valve switching low pressure thereby controlling a linear valve and high pressure spring return actuator. The electric pump replaces a manual hand pump.

FIG. 2B is a schematic drawing of the CFHCS with an electric pump and the piloted 2-way dump valve switching low pressure thereby controlling a quarter-turn valve and high pressure spring return actuator. The electric pump replaces the manual hand pump.

FIG. 3 is outline drawing of the CFHCS with front view, top view and side view.

FIGS. 3A to 3C are outline drawings of another embodiment of the CFHCS. FIG. 3A is a front view. FIG. 3B is a top view. FIG. 3C is a side view. Proprietary parts are labeled.

FIG. 4 is a side view of the manual hand pump in each of its three indexed lever assembly positions.

FIG. 4A is a side view of another embodiment of the manual hand pump with indexed handle assembly positions 1, 2 and 3. Proprietary parts are labeled.

FIG. 4B is a side view of another embodiment of the manual hand pump with indexed handle assembly positions 4, 5 and 6. Proprietary parts are labeled.

FIG. 5 is a cross-sectional view the hand pump and reservoir assembled with the manifold configured for switching low or high pressure.

FIG. 5A is a cross-sectional view of another embodiment of the hand pump and reservoir assembled with the manifold configured for installation and porting of the hand pump, and for switching low or high pressure.

FIG. 6 is a cross-sectional view of the reservoir with oil immersed electric pump assembled with the manifold configured for switching low or high pressure.

FIG. 6A is a cross-sectional view of another embodiment of the reservoir with oil immersed electric pump assembled with the manifold configured for installation and porting of the electric pump, and for switching low or high pressure.

FIG. 7 is a cross-sectional view of the manifolded pressure regulator without system pressure assembled with the manifold configured for switching low or high pressure.

FIG. 8 is a cross-sectional view of the manifolded pressure regulator with system pressure assembled with the manifold configured for switching low or high pressure.

FIG. 8A is a cross-sectional view of another embodiment of the manifolded pressure regulator with system pressure assembled with the manifold configured for switching low or high pressure.

FIG. 9 is a cross-sectional view of the manifolded low pressure volume accumulator without system pressure assembled with the manifold configured for switching low or high pressure.

FIG. 10 is a cross-sectional view of the manifolded low pressure volume accumulator with system pressure assembled with the manifold configured for switching low or high pressure.

FIG. 10A is a cross-sectional view of another embodiment of the manifolded low pressure volume accumulator with system pressure assembled with the manifold configured for switching low or high pressure.

FIG. 11 is a cross-sectional view the manifolded low pressure relief valve without system pressure assembled with the manifold configured for switching low or high pressure.

FIG. 12 is a cross-sectional view of the manifolded low pressure relief valve with system pressure assembled with the manifold configured for switching low or high pressure.

FIG. 12A is a cross-sectional view of another embodiment of the manifolded low pressure relief valve with system pressure assembled with the manifold configured for switching low or high pressure.

FIG. 13 is a cross-sectional view of the manifolded high pressure relief valve without system pressure assembled with the manifold configured for switching low or high pressure.

FIG. 14 is a cross-sectional view of the manifolded high pressure relief valve with system pressure assembled with the manifold configured for switching low or high pressure.

FIG. 14A is a cross-sectional view of another embodiment of the manifolded high pressure relief valve with system pressure assembled with the manifold configured for switching low or high pressure.

FIG. 15 is a cross-sectional view of the manifolded piloted 2-way dump valve switching low pressure with the lever in the dumped position assembled with the manifold configured for switching low pressure only.

FIG. 16 is a cross-sectional view of the manifolded piloted 2-way dump valve switching low pressure with the lever in the leveled position assembled with the manifold configured for switching low pressure only.

FIG. 17 is a cross-sectional view of the manifolded piloted 2-way dump valve switching low pressure with the lever in the charged position assembled with the manifold configured for switching low pressure only.

FIG. 17A is a cross-sectional view of another embodiment of the manifolded piloted 2-way dump valve switching low pressure with lever spring and lever guide in the charged position assembled with the manifold configured for switching low pressure only.

FIG. 18 is a cross-sectional view of the manifolded piloted 2-way dump valve switching high pressure in the dumped position assembled with the manifold configured for switching high pressure only.

FIG. 18A is a cross sectional view of another embodiment of the manifolded piloted 2-way dump valve switching high pressure with lever spring and lever guide in the charged position assembled with the manifold configured for switching high pressure only.

FIG. 19 is a cross-sectional view of the 3-way high and low pressure pilot with 0.562″ diameter sensing piston assembled with body, spool, high spring saddle, low spring plate, and spring nut.

FIG. 20 is a cross-sectional view of the 3-way high and low pressure pilot with 0.312″ diameter sensing piston assembled with spool, high spring saddle, low spring plate, and spring nut.

FIG. 21 is a cross-sectional view of the 3-way high and low pressure pilot with 1.125″ diameter sensing piston assembled with spool, high spring saddle, low spring plate, and spring nut.

FIG. 22 is a cross-sectional view of the 3-way high and low pressure pilot spool at normal sensed pressure position.

FIG. 23 is a cross-sectional view of the 3-way high and low pressure pilot spool at low sensed pressure position.

FIG. 24 is a cross-sectional view of the 3-way high and low pressure pilot spool at high sensed pressure position.

FIG. 25 is a cross-sectional view of another embodiment of the 3-way high and low pressure pilot with body, spool, high spring saddle, low spring plate, and spring nut at normal sensed pressure position.

FIG. 26 is an outline side view and front view of the 3-way high and low pressure pilot with body shown in FIG. 25.

### DETAILED DESCRIPTION OF THE PREFERRED EMBODIMENT(S)

The compact manifolded hydraulic fail safe control system (CFHCS) is used to control the operation of a spring return actuator which, in turn, strokes a pipeline valve from its normal operating position to its fail-safe position, or from the fail-safe position to the normal operating position. All of the fail-safe hydraulic control system proprietary components are assembled and installed into a single pressurized manifold. A piloted 2-way dump valve opens to circulate the spring return actuator's cylinder volume to a reservoir. The pipeline valve will automatically stroke to the required fail-safe position without an external power source. Pipeline valves operated with quarterturn or linear type spring return actuators can be operated using the CFHCS. The piloted 2-way dump valve is opened when the pilot pressure is removed. The CFHCS incorporates a low pressure circuit, a high pressure circuit, or both a low and high pressure circuit.

The pilot pressure to the piloted 2-way dump valve is removed when pipeline pressure exceeds a high or low set-point of a 3-way pressure pilot. Likewise, the piloted 2-way dump valve pilot pressure is removed when a 3-way electric solenoid valve is de-energized. When the piloted 2-way dump valve is opened, the spring return actuator cylinder volume is vented to the reservoir across a regulator (a pressure-regulated cylinder dump) or directly into the reservoir (a low-pressure cylinder or high-pressure cylinder dump). High pressure and low pressure relief valves are used to limit system pressure upstream and downstream of the regulator. A low pressure volume accumulator is provided to accommodate ambient temperature fluctuations.

The CFHCS can be reset, or “re-charged,” by hand pumping in order to refill the spring return actuator cylinder volume and return the pipeline valve to its normal operating position. A lever of the piloted 2-way dump valve is first rotated to the horizontal plane from the vertical plane. A manual hand pump handle is cycled until the spring return actuator and pipeline valve have returned to their normal operating positions. Alternatively, an electrically powered oil immersed pump enclosed in the reservoir is energized to reset or re-charge the system.

The system indicates that it is reset when the lever of the piloted 2-way dump automatically repositions itself in the vertical plane, or “charged” position, and the pipeline valve is in the normal operating position. When reset the system is able to monitor pipeline pressure and process conditions.

The fail-safe valve position of the pipeline valve can also be achieved manually by applying axial hand force to the vertically positioned lever of the piloted 2-way dump valve. This hand force acts against the pilot pressure acting on the piloted 2-way dump valve to manually open the dump valve.

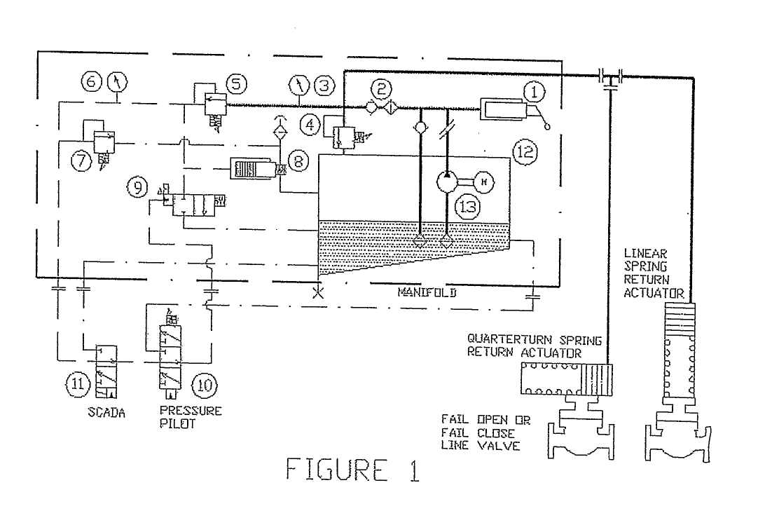

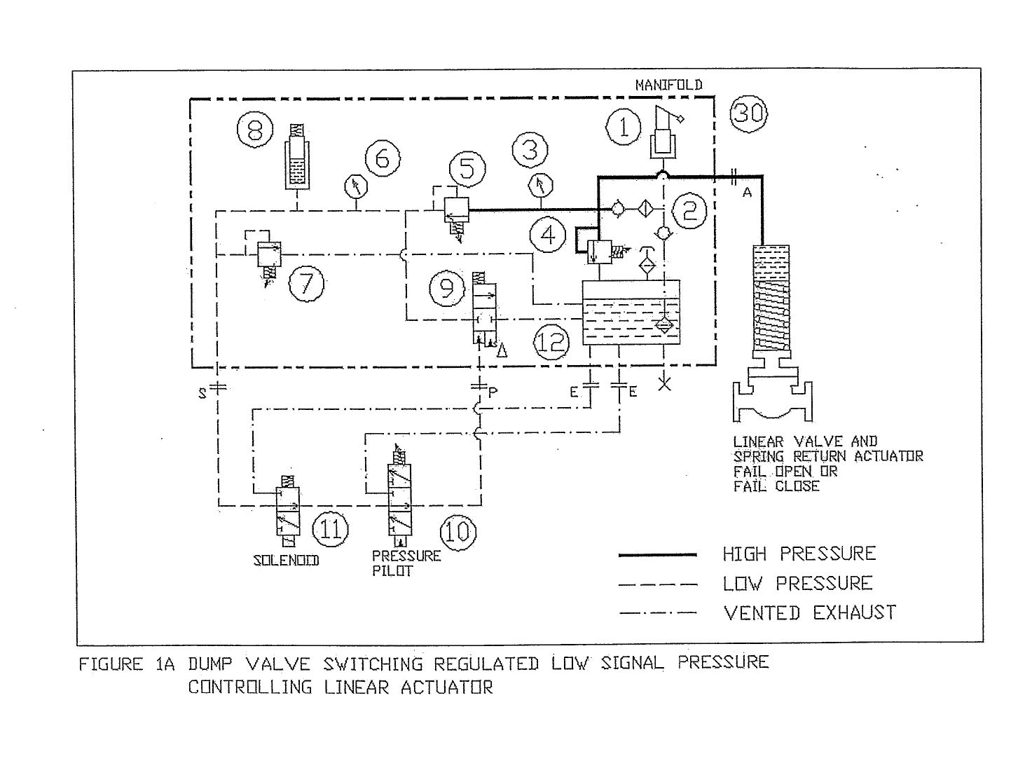

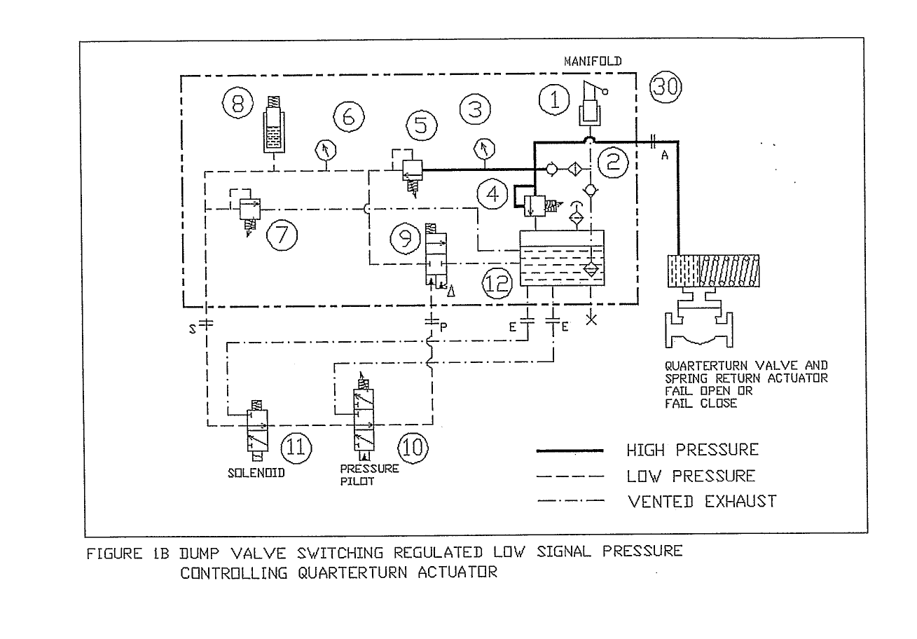

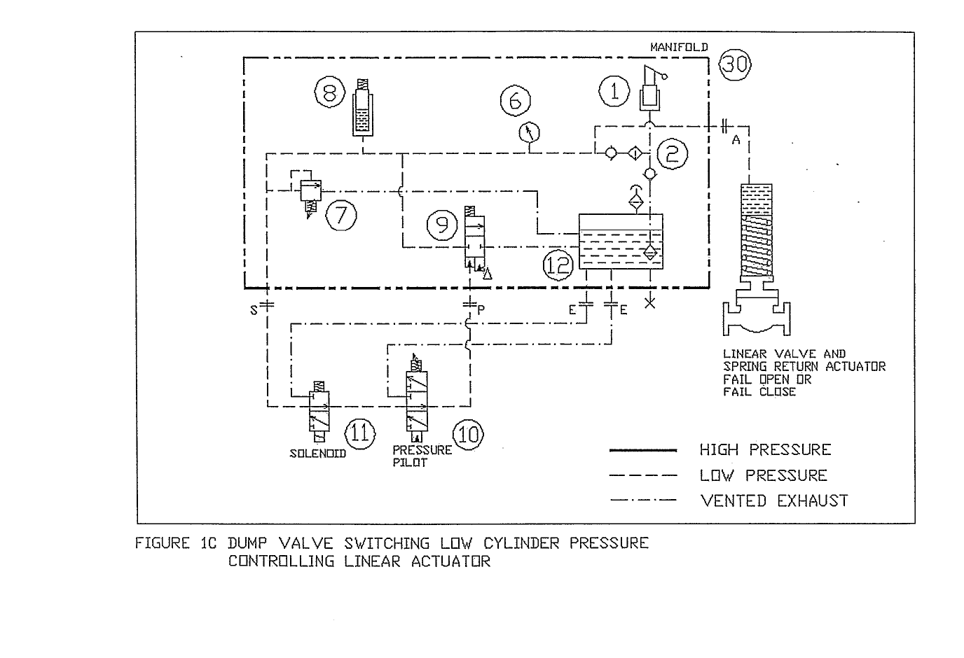

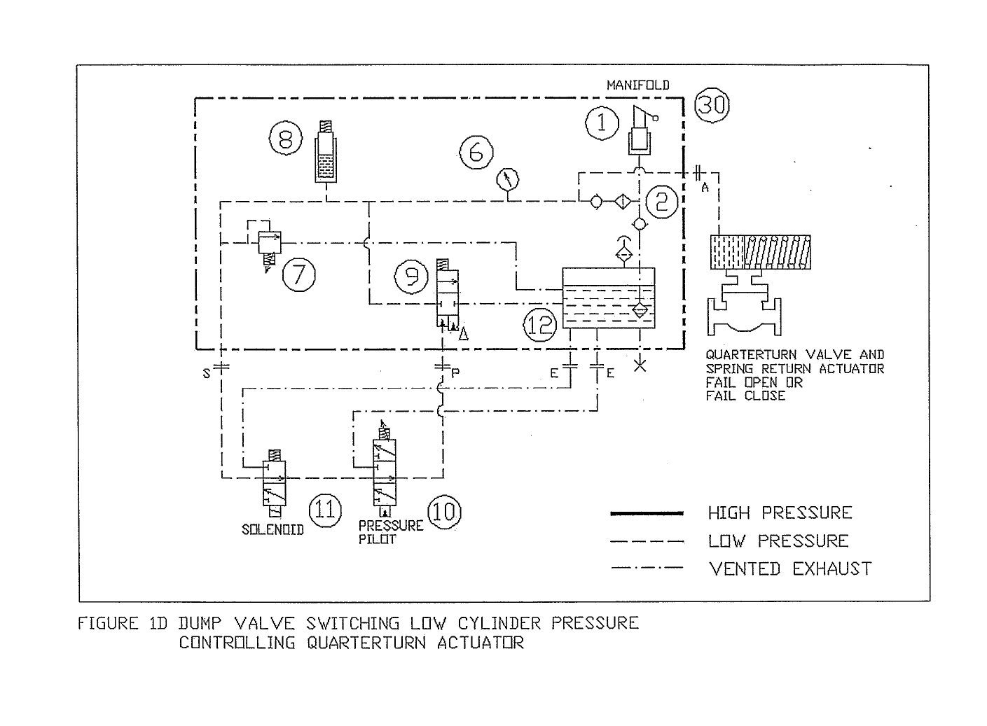

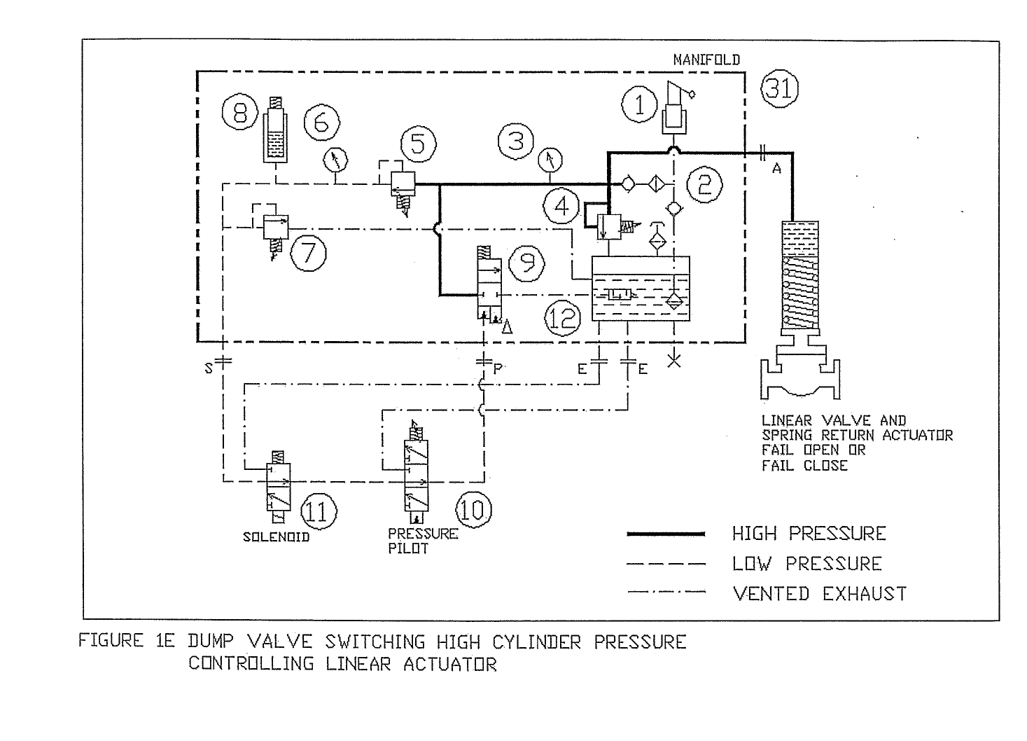

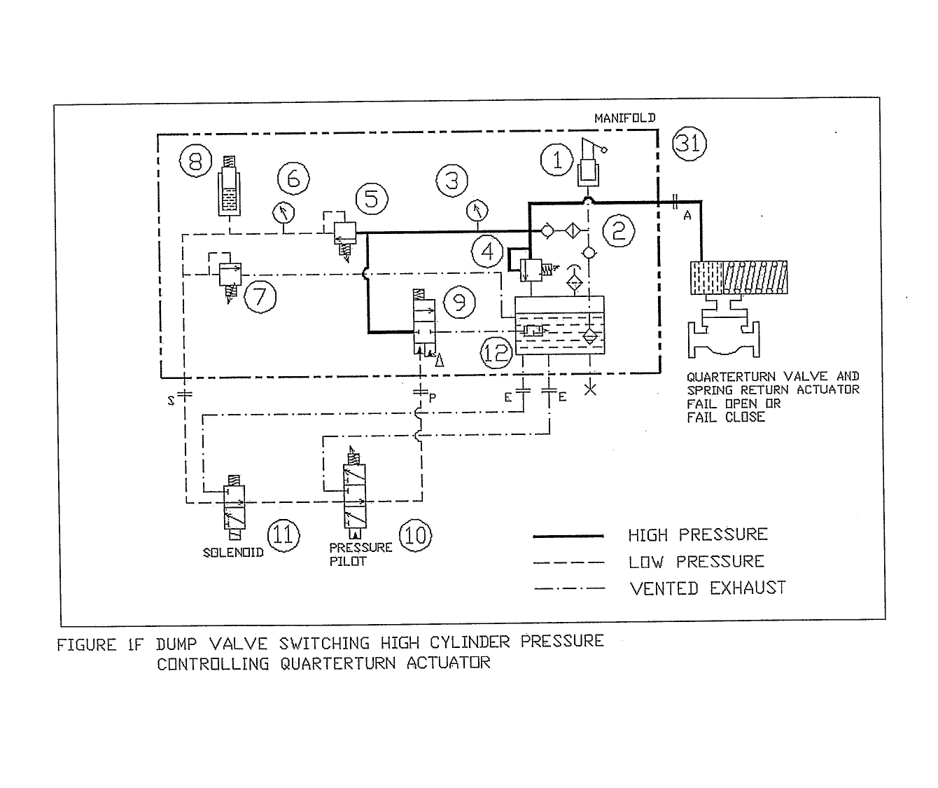

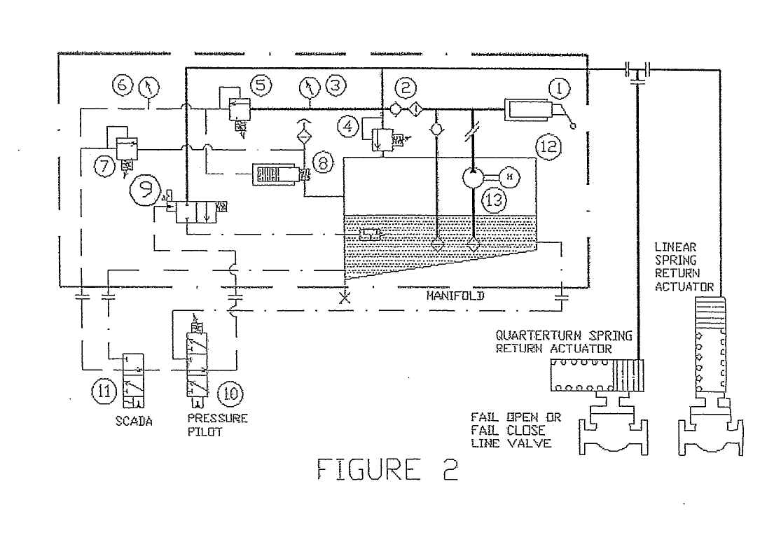

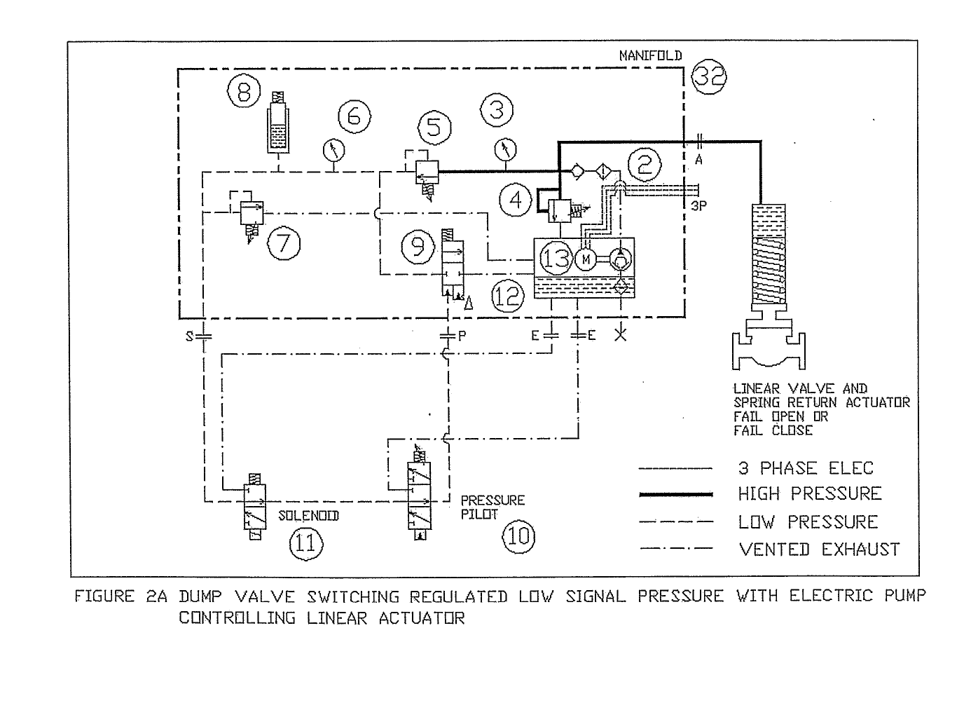

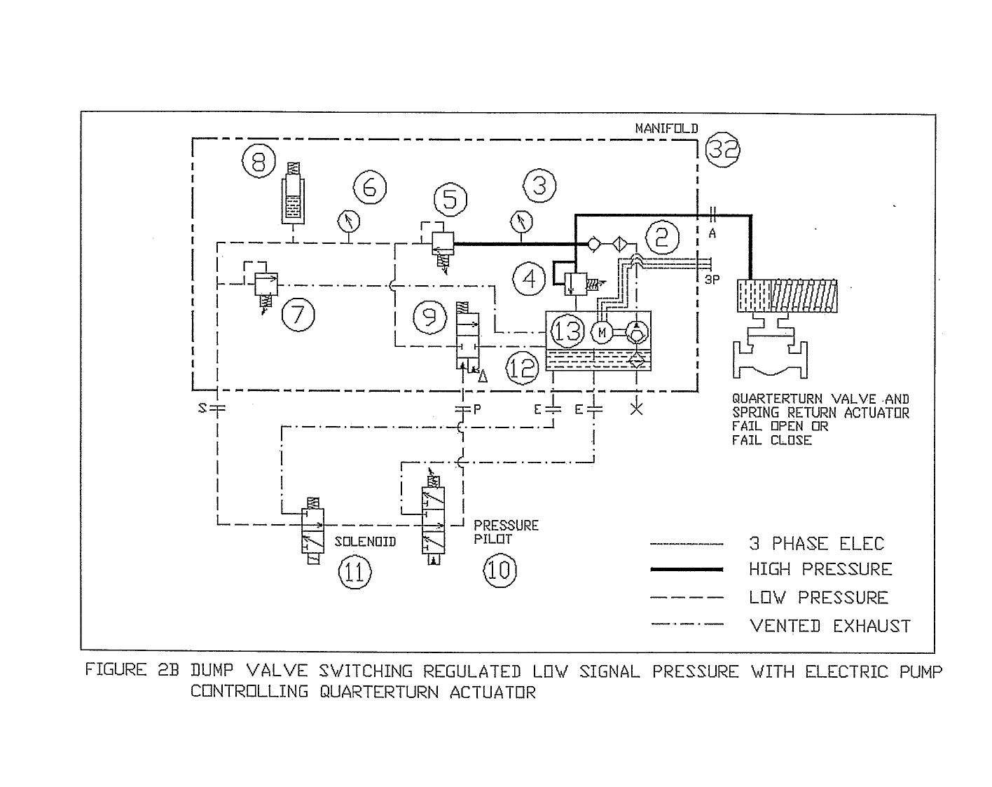

Turning now to the drawings wherein like reference characters indicate like or similar parts throughout, FIGS. 1 to 2B illustrate preferred embodiments of the CFHCS controlling the position of a fail-safe pipeline valve that is mechanically operated using a quarter-turn or linear spring return actuator.

Referring to FIG. 1, the CFHCS consists of two separate control circuits. The spring return actuator cylinder volume is regulated to low pressure before it is vented to fully contained reservoir 12. Controlling the position of a fail-safe pipeline valve is possible with or without electric solenoid valve 11. The single manifold 20 provides the necessary porting to connect all of the proprietary control components.

Referring to FIGS. 1A and 1B, the CFHCS is shown controlling the position of a fail-safe pipeline valve that is mechanically operated using a quarter-turn or linear spring return actuator. The single manifold 30 consists of two separate control circuits. A high pressure circuit is connected to the spring return actuator cylinder volume and is maintained at high pressure. A low pressure circuit is connected to the high pressure circuit across a pressure regulator 5 and is maintained at low pressure.

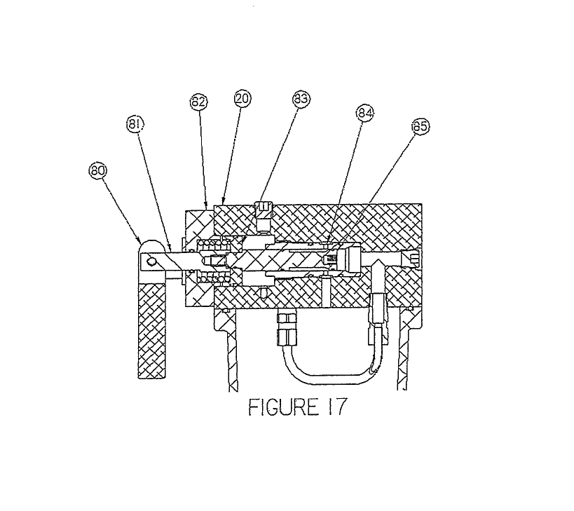

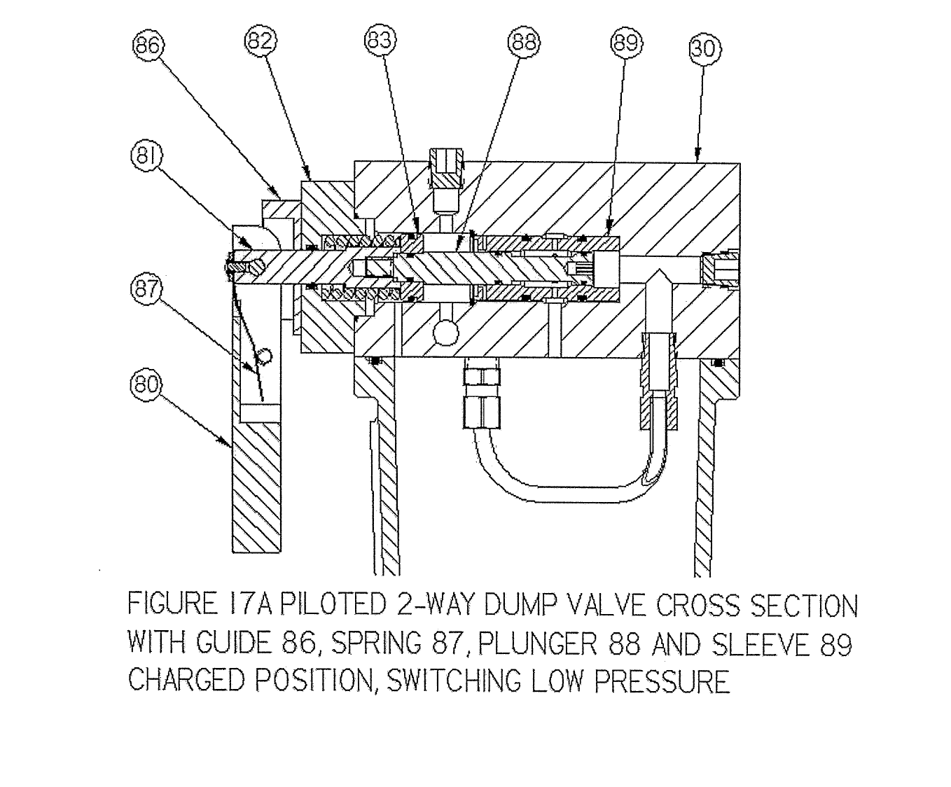

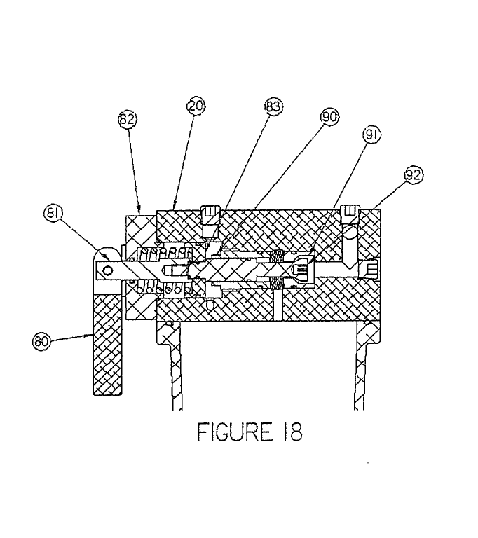

The high pressure circuit is supplied with fluid from fully contained reservoir 12 when manual hand pump 1 is operated. Check valve 2, pressure regulator 5, high pressure relief valve 4, and the spring return actuator cylinder volume are connected in a certain sequence as illustrated. Piloted 2-way dump valve 9 controls the position of the pipeline valve by switching open or closed based upon the pressure in the low pressure control circuit. When the piloted 2-way dump valve 9 is opened, the spring return actuator cylinder volume fluid is vented to fully contained reservoir 12. Controlling the position of a fail-safe pipeline valve is possible with or without the 3-way electric solenoid valve 11. The 3-way electric solenoid 11 provides an additional control feature for an end user who has an electric power source and needs to utilize remote control of the failsafe valve. The single manifold 30 provides the necessary porting to connect all 41 proprietary control components. Manifold 30 is unique in that a machined bore which contains the low pressure plunger 85 and low pressure sleeve 89 of piloted 2-way dump valve 9 switching low pressure (see FIG. 17A) will not accept the high pressure plunger 92 and high pressure sleeve 90 of piloted 2-way dump valve 9 switching high pressure (see FIG. 18A).

The low pressure control circuit is supplied with fluid across pressure regulator 5 when the spring return actuator cylinder is supplied with fluid by hand pump 1. Check valve 2, pressure regulator 5, low pressure volume accumulator 8, low pressure relief valve 7, piloted 2-way dump valve 9, 3-way high and low pressure pilot 10, and 3-way electric solenoid valve 11 are connected in a certain sequence as illustrated. The outline of manifold 30 is shown to illustrate that hand pump 1, low pressure regulator 5, low pressure volume accumulator 8, low pressure relief valve 7, high pressure relief valve 4, and piloted 2-way dump valve 9 are assembled within the single manifold 30.

The CFHCS remains in a pressurized state, with the pipeline valve in its normal operating position, as long as 3-way high and low pressure pilot 10 is sensing pipeline pressure between a high and low set point, or as long as 3-way electric solenoid valve 11 remains energized, or as long as 3-way high and low pressure pilot 10 is sensing pipeline pressure between a high and low set point and the 3-way electric solenoid valve 11 remains energized. If 3-way high and low pressure pilot 10 opens due to pipeline pressure that is too high or too low, or if 3-way electric solenoid valve 11 opens due to being de-energized, then low pressure vents to fully contained reservoir 12 and piloted 2-way dump valve 9 is opened. To stroke the pipeline valve to its fail-safe position, piloted 2-way dump valve 9 opens due to the loss of pilot pressure. Subsequently, actuator cylinder high pressure fluid is vented across pressure regulator 5 and the open piloted 2-way dump valve 9, into fully contained reservoir 12 which has a breather and fill cap.

Manual operation of hand pump 1 is required to reset or re-charge the CFHCS. Piloted 2-way dump valve 9 must be manually repositioned before manual hand pumping can begin. The lever of piloted 2-way dump valve 9 is rotated up 90° from a vertical plane to a horizontal plane to engage lever spring load and be placed in the “leveled” position. Hand pump 1 can then be manually operated by lifting up and pushing down on handle 21 of hand pump 1. The required operating force of hand pump 1 increases as CFHCS pressure increases. As hand pump 1 is operated, fluid flows from fully contained reservoir 12 through a screen and a filter before passing check valve 2. Manual pumping re-pressurizes low pressure volume accumulator 8 as determined by the set points of regulator 5 and low pressure relief valve 7. The actuator cylinder re-pressurizes as limited by a set point of high pressure relief valve 4.

Referring to FIGS. 1C and 1D, the CFHCS is shown controlling the position of a fail safe pipeline valve that is mechanically operated utilizing a quarter-turn or linear spring return actuator. The single manifold 30 consists of one low pressure circuit. The low pressure circuit is connected to the spring return actuator cylinder volume and is at low pressure. Pressure regulator 5 and high pressure relief valve 4 are not necessary for the control of this CFHCS configuration. Piloted 2-way dump valve 9 controls the position of the pipeline valve by switching open or closed based upon the pressure in the low pressure circuit. When the piloted 2-way dump valve 9 is opened, the spring return actuator cylinder volume fluid is vented to fully contained reservoir 12. Controlling the position of a fail-safe pipeline valve is possible with or without 3-way electric solenoid valve 11. The single manifold 30 provides the necessary porting to connect all 36 proprietary control components.

The low pressure control circuit is supplied with fluid when the spring return actuator cylinder is supplied with fluid by hand pump 1. Check valve 2, low pressure volume accumulator 8, low pressure relief valve 7, piloted 2-way dump valve 9, 3-way high and low pressure pilot 10, and 3-way electric solenoid valve 11 are connected in a certain sequence as illustrated. The outline of manifold 30 is shown to illustrate that hand pump 1, low pressure volume accumulator 8, low pressure relief valve 7, and piloted 2-way dump valve 9 are assembled within the single manifold 30.

Operation of 3-way high and low pressure pilot 10 and 3-way electric solenoid valve 11 occurs in a manner similar to those described in connection with the control circuits illustrated in FIGS. 1A and 1B. To stroke the pipeline valve to its fail-safe position, piloted 2-way dump valve 9 opens due to the loss of pilot pressure. Subsequently, actuator cylinder low pressure fluid is vented across the open piloted 2-way dump valve 9 and into fully contained reservoir 12 which has a breather and fill cap. Manual operation of hand pump 1 is required to reset or re-charge the CFHCS. Operation of hand pump 1 occurs in a manner similar to that as described in connection with the control circuits illustrated in FIGS. 1A and 1B. Manual pumping re-pressurizes low pressure volume accumulator 8 and the actuator hydraulic cylinder as limited by a set point of low pressure relief valve 7.

Referring to FIGS. 1E and 1F, the CFHCS is shown controlling the position of a fail-safe pipeline valve that is mechanically operated utilizing a quarter-turn or linear spring return actuator. The single manifold 31 consists of two separate control circuits. A high pressure circuit is connected to the spring return actuator cylinder volume and is maintained at high pressure. A low pressure control circuit is connected to the high pressure circuit across pressure regulator 5 and is maintained at low pressure. Manifold 31 is unique in that a machined bore which contains the high pressure plunger 92 and high pressure seat 91 of piloted 2-way dump valve 9 switching low pressure (see FIG. 18A) will not accept the low pressure plunger 88 and low pressure sleeve 89 of piloted 2-way dump valve 9 switching high pressure (see FIG. 17A).

The high pressure control circuit is supplied with fluid from fully contained reservoir 12 when manual hand pump 1 is operated. Check valve 2, pressure regulator 5, high pressure relief valve 4, and the spring return actuator cylinder volume are connected in a certain sequence as illustrated. Piloted 2-way dump valve 9 controls the position of the pipeline valve by switching open or closed based on the pressure in the low pressure circuit. When the piloted 2-way dump valve 9 is opened, the spring return actuator cylinder volume fluid is vented into fully contained reservoir 12. Controlling the position of a fail-safe pipeline valve is possible with or without 3-way electric solenoid valve 11. The single manifold 31 provides the necessary porting to connect all 43 proprietary control components.

Control of the low pressure circuit occurs in a manner similar to those described in connection with the control circuits illustrated in FIGS. 1A and 1B. Operation of 3-way high and low pressure pilot 10 and 3-way electric solenoid valve 11 occurs in a manner similar to those described in connection with the control circuits illustrated in FIGS. 1A and 1B. To stroke the pipeline valve to its fail-safe position, piloted 2-way dump valve 9 opens due to the loss of low pressure. Subsequently, actuator cylinder high pressure is vented directly across the open piloted 2-way dump valve 9 and diffuser, into the fully contained reservoir 12 which has a breather and fill cap. Manual operation of hand pump 1 is required to reset or re-charge the CFHCS. Operation of hand pump 1 occurs in a manner similar to that as described in connection with the control circuits illustrated in FIGS. 1A and 1B.

Referring to FIG. 2 piloted 2-way dump valve 9 is connected to the high pressure circuit. The spring return actuator cylinder volume is vented directly to reservoir 12 across a diffuser. Controlling the position of a fail-safe pipeline valve is possible with or without 3-way electric solenoid valve 11. The single manifold 20 provides the necessary porting to connect all of the proprietary control components.

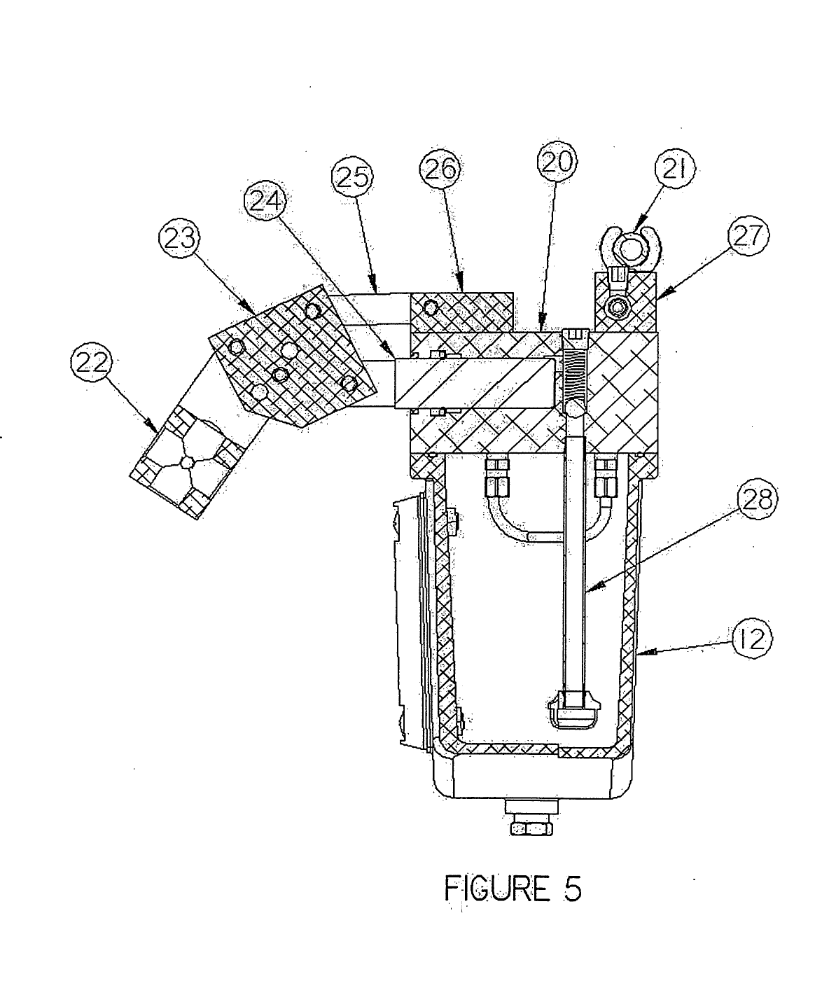

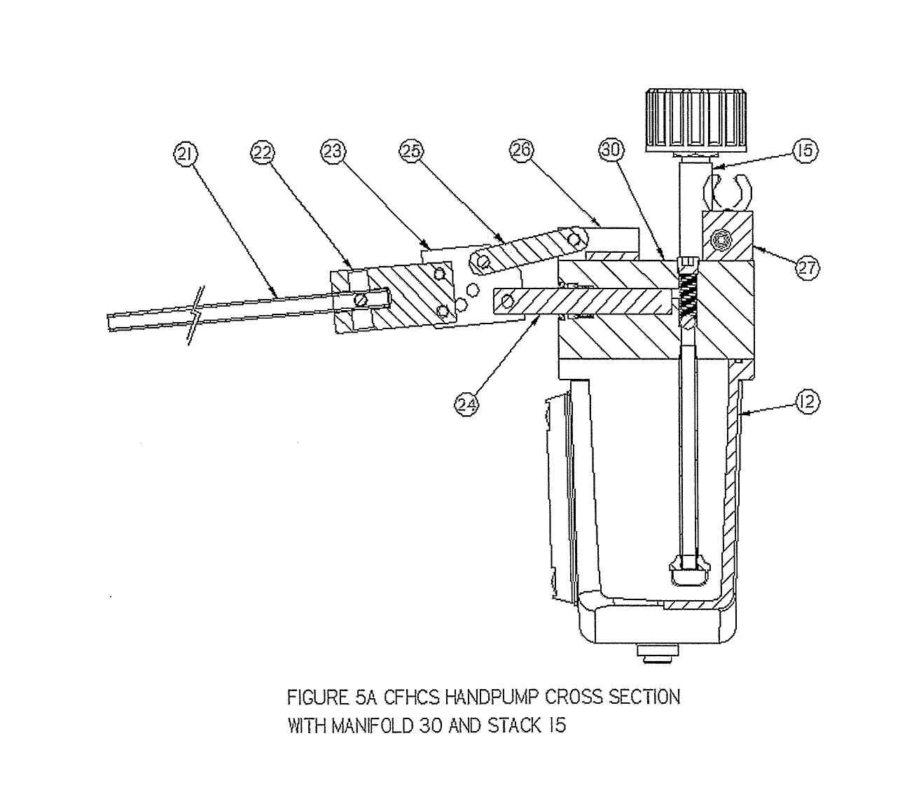

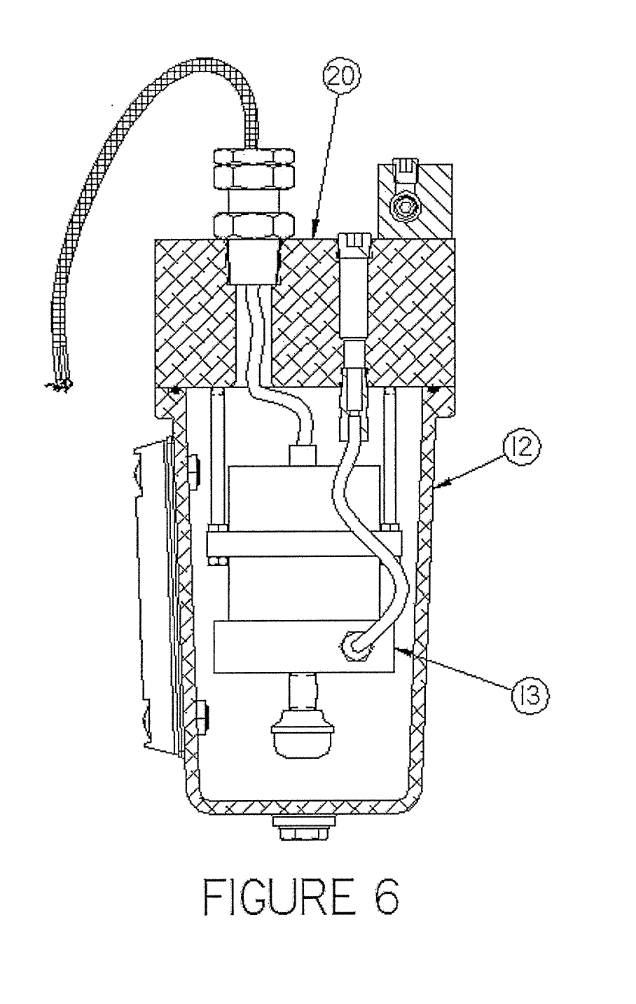

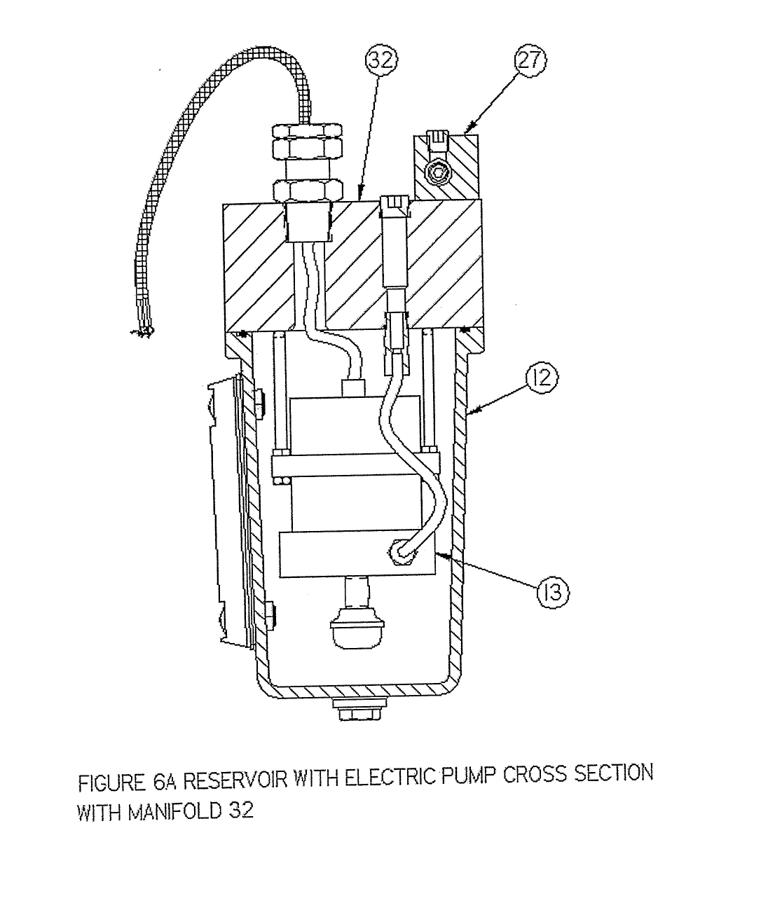

Referring to FIGS. 2A and 2B, the CFHCS is shown controlling the position of a fail-safe pipeline valve that is mechanically operated utilizing a quarter-turn or linear spring return actuator. The single manifold 32 consists of two separate control circuits. A high pressure circuit is connected to the spring return actuator cylinder volume and is maintained at high pressure. A low pressure control circuit is connected to the high pressure circuit across pressure regulator 5 and is maintained at low signal pressure. The actuator is re-pressurized by electric pump 13. Hand pump 1 and the fill and breather cap of reservoir 12 are not necessary. Manifold 32 is unique in that the machined bore which contains the components of hand pump 1 (see FIG. 5A) is not provided; in its place is the necessary mounting bolt pattern and different porting to suit the installation of oil immersed electric pump 13 (see FIG. 6A).

Control of the low pressure circuit occurs in a manner similar to those described in connection with the control circuits illustrated in FIGS. 1A and 1B. Control of the high pressure circuit occurs in a manner similar to those described in connection with the control circuits illustrated in FIGS. 1A and 1B. Operation of 3-way high and low pressure pilot 10 and 3-way electric solenoid valve 11 also occurs in a manner similar to those described in connection with the control circuits illustrated in FIGS. 1A and 1B.

To automatically stroke the pipeline valve to its fail-safe position, one of the control techniques illustrated FIGS. 1A through 1F is used in combination with electric pump 13. The electric pump 13 and 3-way solenoid valve 11 are re-energized to reset or re-charge the CFHCS and return the pipeline valve to its normal operating position. The single manifold 32 provides the necessary porting to connect all 35 proprietary control components. Another embodiment of the CFHCS with electric pump 13 could use piloted 2-way dump valve 9 configured for switching high pressure (see FIG. 18A).

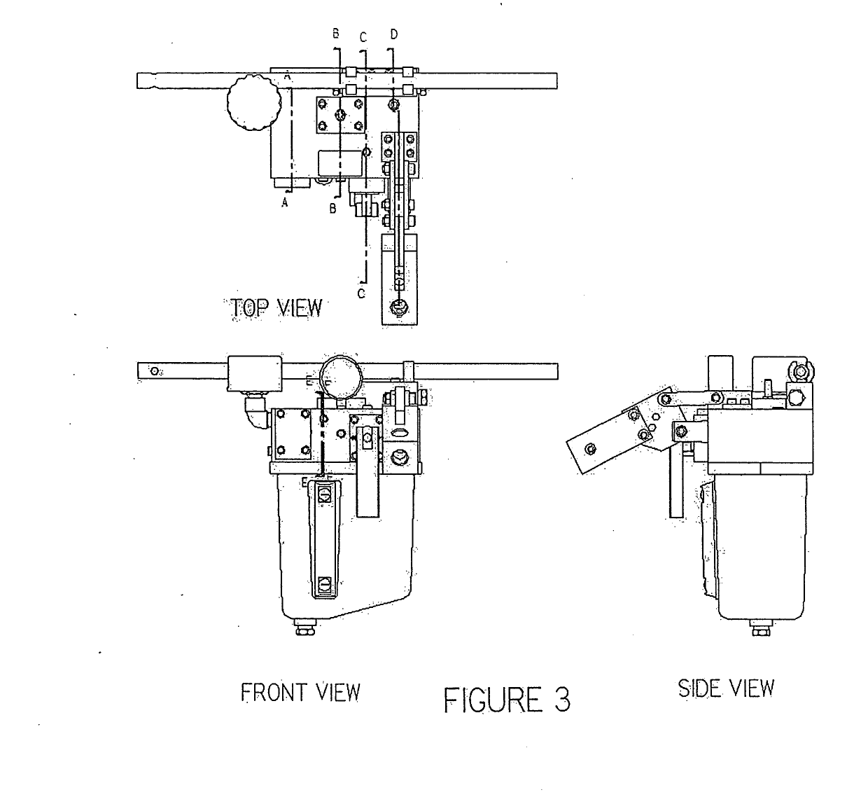

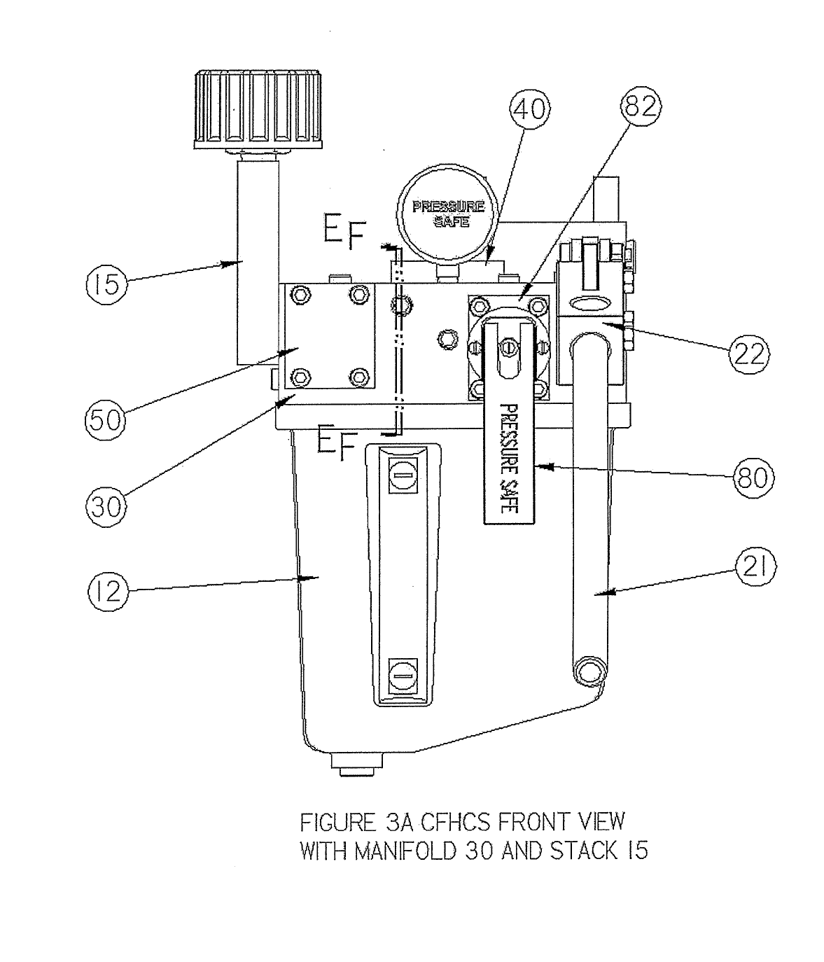

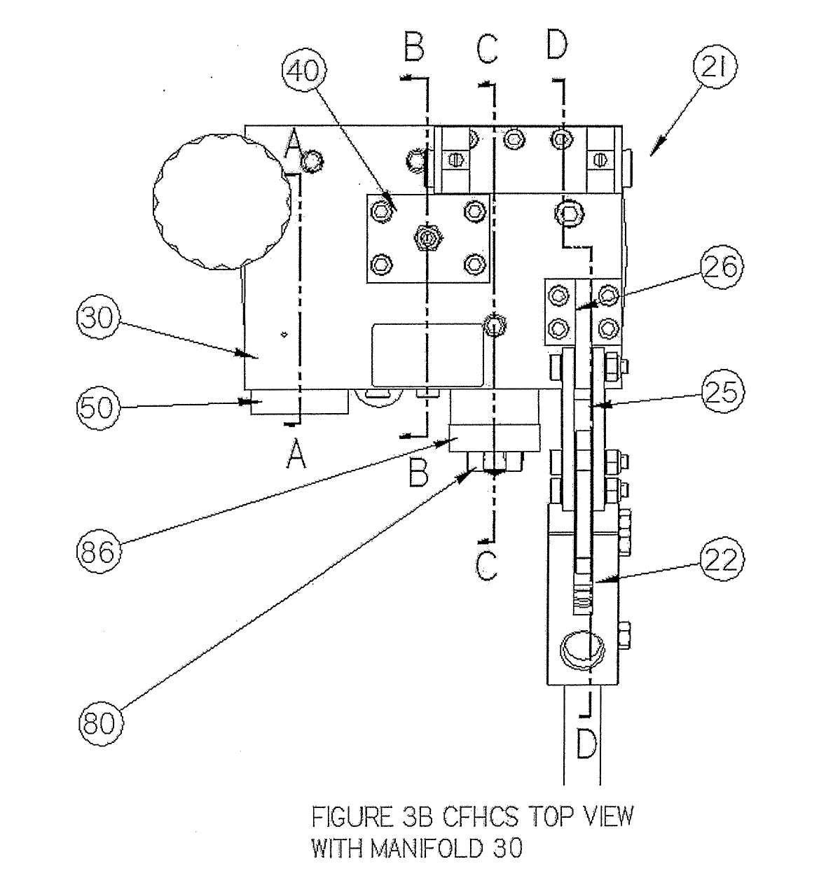

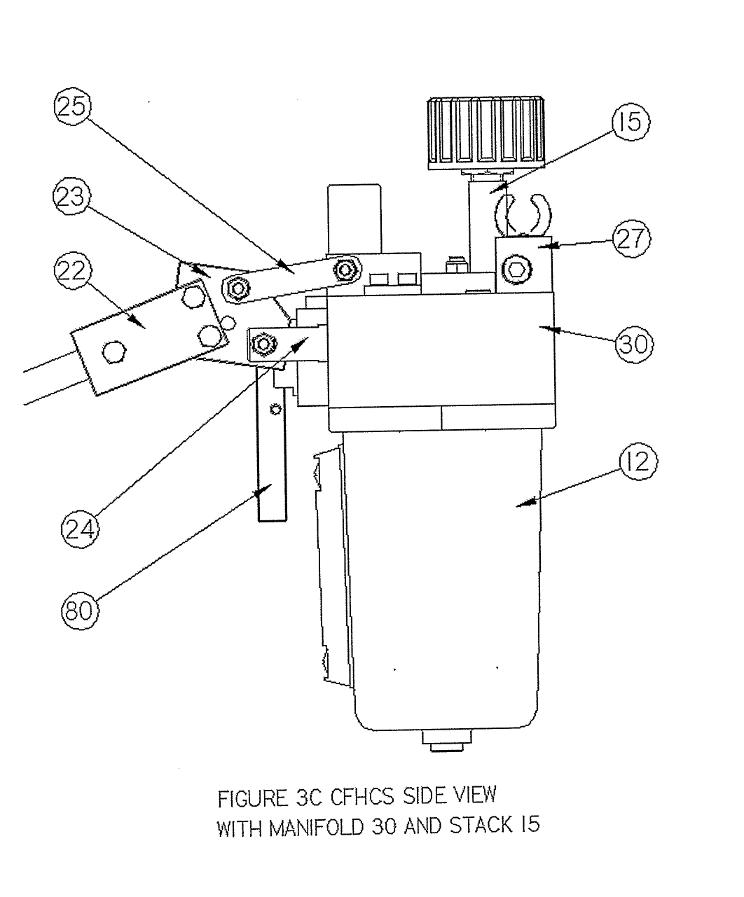

Referring to FIG. 3 there is shown a top view, front view and side view of CFHCS. The rectangular profile of reservoir 12 matches the profile of the single manifold 20, thereby maximizing the useful volume in reservoir 12. The front profile of reservoir 12 shows a sloped bottom provided to collect solid debris adjacent to a drain port and away from the inlet screen of hand pump 1.

Another embodiment of hand pump 1 is shown in FIGS. 3A to 3C. Handpump 1 is provided in the CFHCS as illustrated in FIGS. 1A to 1F, and not provided in the CFSHC with electric pump 13 as illustrated in FIGS. 2A and 2B. Except for hand pump 1 and its proprietary components, the CFHCS illustrated in FIGS. 1A to 2B fit within the same outline when assembled in single manifolds 30, 31, or 32.

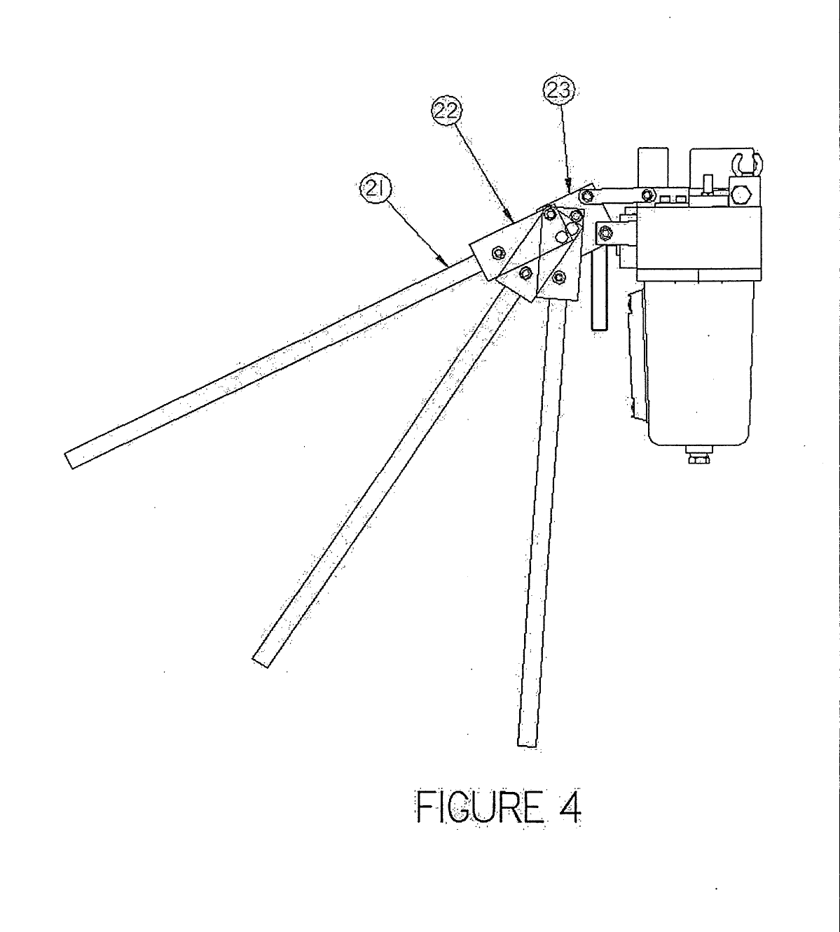

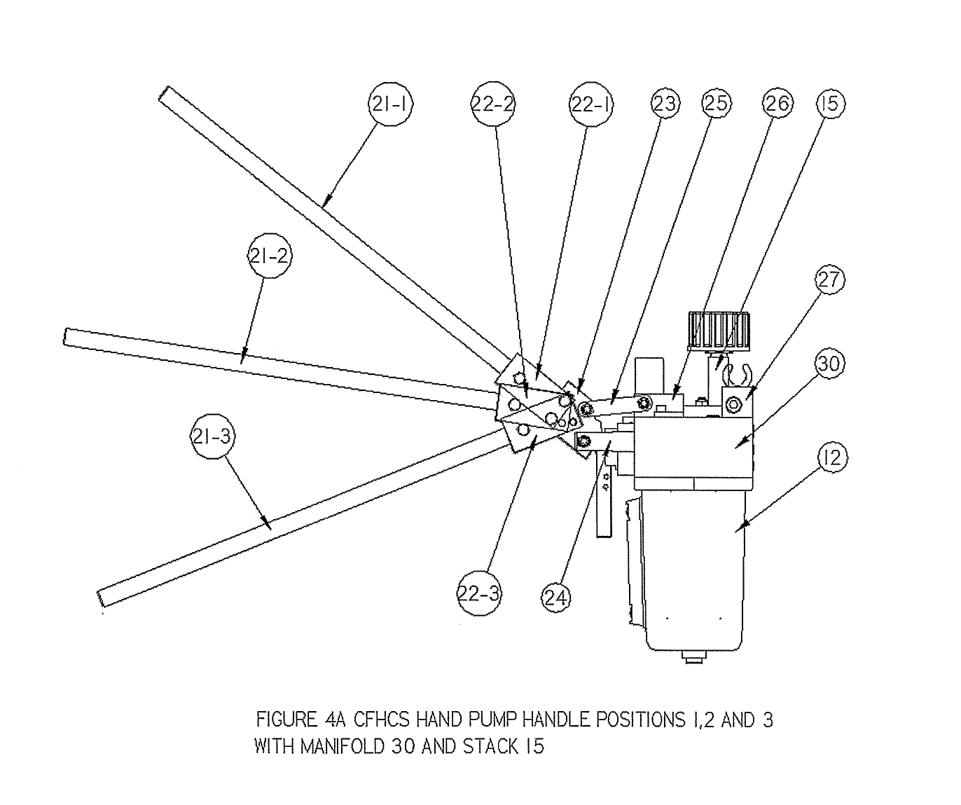

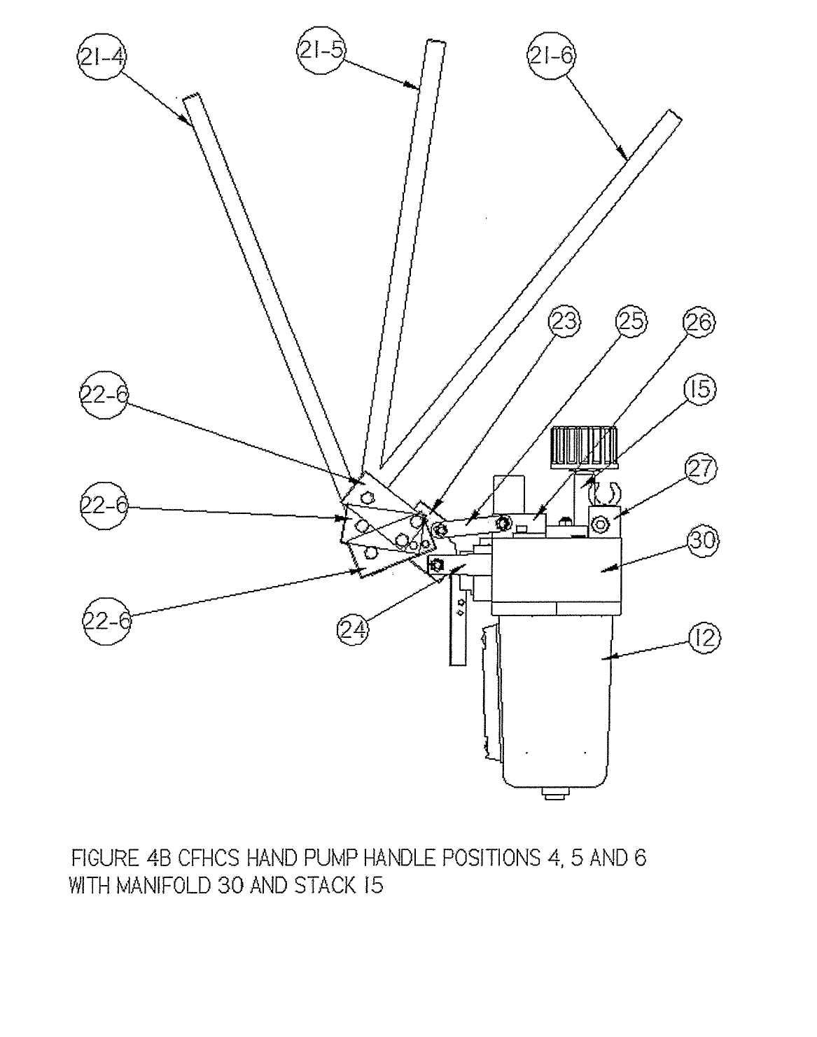

Referring to FIG. 4 there is shown in profile a side view of the CFHCS with hand pump handle 21 assembled in lever 22 of hand pump 1. Three operating positions are provided for hand pump handle 21 and lever 22. Hand pump 1 is assembled into single manifold 20.

Another embodiment of hand pump 1 is shown in FIGS. 4A and 4B. Hand pump handle 21 is assembled into lever 22. A total of six indexed positions 21-1 to 21-6 are provided for the assembled handle 21. Lever 22 pivots about a bolt engaged in lever plate 23. A second bolt installed through lever 22 engages a circular bolt pattern provided in lever plate 23. Lever plate 23 includes three holes equally spaced within a sixty-degree pattern. Lever 22 has two holes which intersect at 90 degrees and either hole receives handle 21. Handle 21 is bolted to lever 22 through an intersecting bolt hole. The two holes intersecting at 90 degrees in lever 22, combined with the three-hole 60 degree pattern in lever plate 23, provide a total of six assembled handle 21 positions.

Referring to FIG. 5, hand pump 1 is assembled into manifold 20 using an additional nine proprietary parts. The module 27 assembly includes an elevated pipe plug in order to provide a means of venting entrained air from the high pressure circuit of the CFHCS.

Another embodiment of hand pump 1 is shown in FIG. 5A. Hand pump 1 is assembled into manifold 30 using an additional nine proprietary parts. (Assembly of the hand pump 1 into manifold 31 occurs in a manner similar to those described in connection with manifold 30.) Piston 24 cycles in a horizontal plane within a standard bushing, preferably made of plastic, and contained in a matching bore provided in manifold 30. The bushing forms one shoulder of a seal groove to maintain seal concentricity, reduce operating friction, and minimize eccentric loading of the seal. Piston 24 is manually cycled axially by pushing and pulling up and down on assembled handle 21 in a rhythmic fashion. Fluid flows from the fully contained reservoir 12 into and out of the volume created in the matching bore provided in manifold 30, with the volume in the matching bore increasing and decreasing as piston 24 is manually cycled axially. As the volume of piston 24 decreases, fluid flows into the spring return actuator fluid cylinder and is maintained by check valve 2. The breather and filler cap of reservoir 12 is elevated and threaded into the top of stack 15. Stack 15 is bolted and sealed onto the side of manifold 30.

Piston 24 is loaded in compression when link 25 is in tension. When link 25 is loaded in tension there are no resulting bending stresses, only simple tension stresses and contact stresses. Link 25 is loaded in tension by manually pushing down on handle 21. At one end two entities of link 25 are pinned to lever plate 23 and bracket 26 with washers, preferably made of plastic, installed to reduce friction. At the other end two entities of link 25 are pinned to piston 24. Bracket 26 is bolted to manifold 30.

Module 27 is assembled with a discharge filter and check valve 2 and bolted and sealed to manifold 30. Module 27 can be removed from manifold 30 and replaced as a cartridge without any further disassembly of the other proprietary components of hand pump 1.

Referring to FIG. 6 the oil immersed electric pump 13 is assembled into fully contained reservoir 12 and fully contained manifold 20. The fully contained reservoir 12 does not require the fill and breather cap. Manifold 20 is modified by the addition of porting to connect the oil immersed electric pump 13 to the other control components, and the addition of a cover to enclose the matching bore provided for hand pump 1.

Another embodiment of oil immersed electric pump 13 is shown in FIG. 6A. Oil immersed electric pump 13 replaces hand pump 1 and is enclosed within fully contained reservoir 12 and single manifold 32. Oil immersed electric pump 13 is assembled with manifold 32 using two additional proprietary parts. When oil immersed electric pump 13 is re-energized, fluid flows from fully contained reservoir 12 into the spring return actuator cylinder volume where it is maintained by check valve 2. Fully contained reservoir 12 does not require the fill and breather cap when assembled with manifold 32.

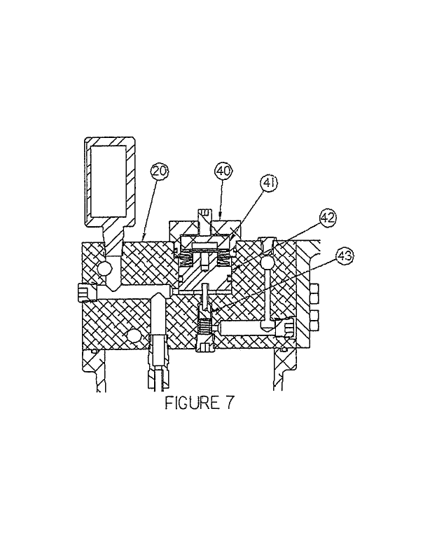

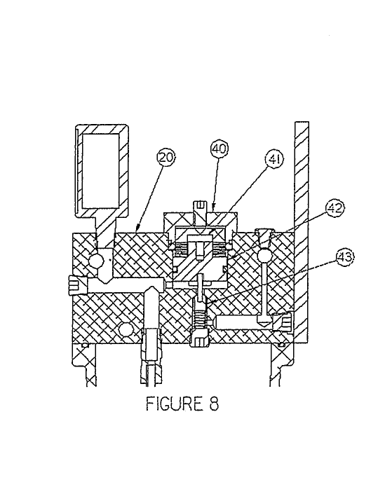

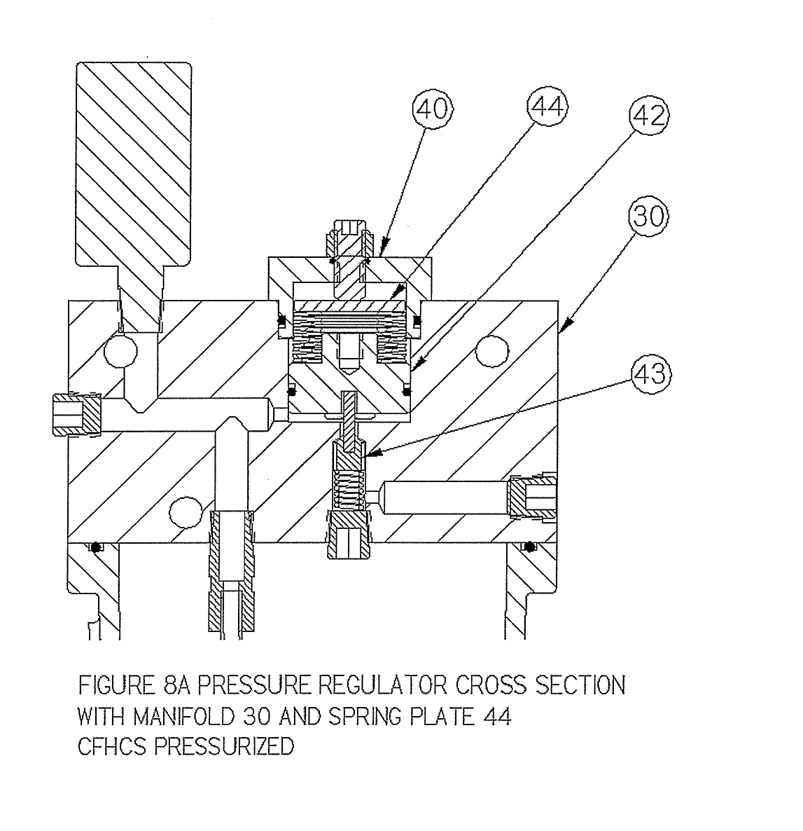

Referring to FIGS. 7 and 8, pressure regulator 5 is assembled into manifold 20 using four additional proprietary parts. Plate 41 is counter bored on its bottom side and contains a stack of Belleville spring washers. FIG. 7 shows the CFHCS without pressure and poppet 43 disengaged from a matching seal edge provided in manifold 20. FIG. 8 shows the CFHCS with pressure and poppet 43 engaged with the matching seal edge provided in manifold 20.

Another embodiment of pressure regulator 5 is shown in FIG. 8A. Pressure regulator 5 is assembled into manifold 30 using four additional proprietary parts. (Assembly of pressure regulator 5 into manifolds 31 and 32 occurs in a manner similar to those described in connection with manifold 30.) Piston 42 and poppet 43, both preferably made of plastic to reduce friction, both cycle in the vertical plane in matching bores provided in manifold 30. A slot cut across and through a short raised small diameter end face of piston 42 provides a fluid flow path to poppet 43. Shown with the CFCHS pressurized and poppet 43 in the normal operating position, the short raised small diameter end face of piston 42 is not contacting the mating face provided in manifold 30. A bore is provided at this end of piston 42 to receive and contact the end face of a pin. The pin is assembled tightly into a mating bore provided in the tapered end of poppet 43 and thereby maintains the assembled distance relative to this end of piston 42. Poppet 43 is provided with four axial radially profiled grooves along its outside diameter to provide a flow path to fully contained reservoir 12.

Coil spring load is exerted against the flat end face of poppet 43. The coil spring is contained in a matching bore provided in manifold 30 by a pipe plug. An assembled Belleville spring washer stack exerts an opposing spring load against piston 42. A flat spring plate 44 is installed over, and compresses, the stack of Belleville spring washers. A set screw is threaded through cover 40 against flat spring plate 44, and is used to adjust the assembled Belleville spring stack load applied against piston 42. Cover 40 is bolted to and sealed against manifold 30. A lock nut with seal positions the set screw and sets the assembled Belleville spring stack load.

Poppet 43 seals the difference in pressure between the high pressure circuit and low pressure circuit. The tapered end of poppet 43 seals against a matching edge provided in manifold 30 unless low pressure drops to a pressure where the low pressure force exerted on piston 42 is less than the opposing force exerted by the pre-set Belleville spring stack load. In this event, piston 42 cycles toward the matching face provided in manifold 30, thereby disengaging the poppet 43 from the matching edge provided in manifold 30, allowing high pressure circuit fluid to flow across poppet 43 into the low pressure circuit.

When piston 42 cycles toward the matching face provided in manifold 30, the pin maintains the assembled spacing relative to poppet 43. Poppet 43 follows the movement of piston 42, thereby disengaging the seal edge provided on manifold 30. When low pressure increases to the point where the low pressure force exerted on piston 42 is greater than the opposing pre-set force of the assembled Belleville spring stack load, piston 42 cycles away from the matching face provided in manifold 30 compressing the stack of Belleville washers. Subsequently poppet 43 re-engages the matching seal edge provided on manifold 30 re-sealing the high pressure circuit from the low pressure circuit.

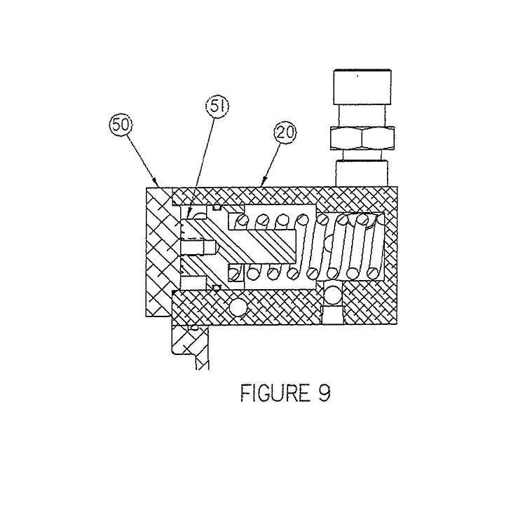

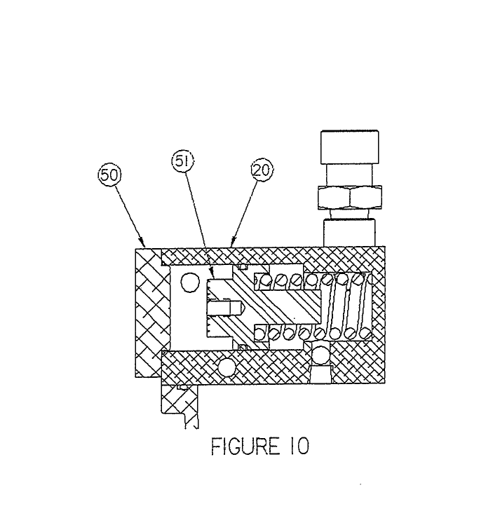

Referring to FIGS. 9 and 10, low pressure volume accumulator 8 is assembled into manifold 20 using two additional proprietary parts. Manifold 20 provides a straight matching bore for piston 51. FIG. 9 shows the CFHCS without pressure and piston 51 contacting cover 50. FIG. 10 shows the CFHCS with pressure and piston 51 disengaged from cover 50.

Another embodiment of low pressure volume accumulator 8 is shown in FIG. 10A. Low pressure volume accumulator 8 is assembled into manifold 30 using two additional proprietary parts. (Assembly of low pressure volume accumulator 8 into manifolds 31 and 32 occurs in a manner similar to those described in connection with manifold 30.) The low pressure accumulator 8 has capacity to accommodate displacement generated by the piston area of piloted 2-way dump valve 9 when piloted 2-way dump valve 9 is manually opened. Cover 50, which is bolted to and sealed against manifold 30, determines the assembled position of and the assembled coil spring load exerted on piston 51. Shown with the CFHCS pressurized and piston 51 in the normal operating position, the extended small diameter end of piston 51 does not contact the matching face provided in manifold 30.

Piston 51, preferably made of plastic to reduce friction, cycles in the horizontal plane in a matching bore provided in manifold 30. The matching bore provided in manifold 30 is oversized relative to piston 51, in the region of a cross-drilled hole, to protect the seal of piston 51 from damage during assembly and disassembly. A single spiral groove circles the end face of piston 51 approximately three times to ensure evenly distributed pressure when piston 51 is in its starting position and contacting cover 50. Piston 51 provides an extended small diameter end to further engage the inside diameter of the coil spring as low pressure increases.

The force of piston 51 is generated by increasing fluid volume in the low pressure volume accumulator 8. As fluid volume increases in low pressure volume accumulator 8, the coil spring load opposes the force generated by piston 51. As low pressure in the CFHCS increases or decreases, or when piloted 2-way dump valve 9 is opened or closed, fluid flows between the matching bore provided in manifold 30 and the low pressure circuit.

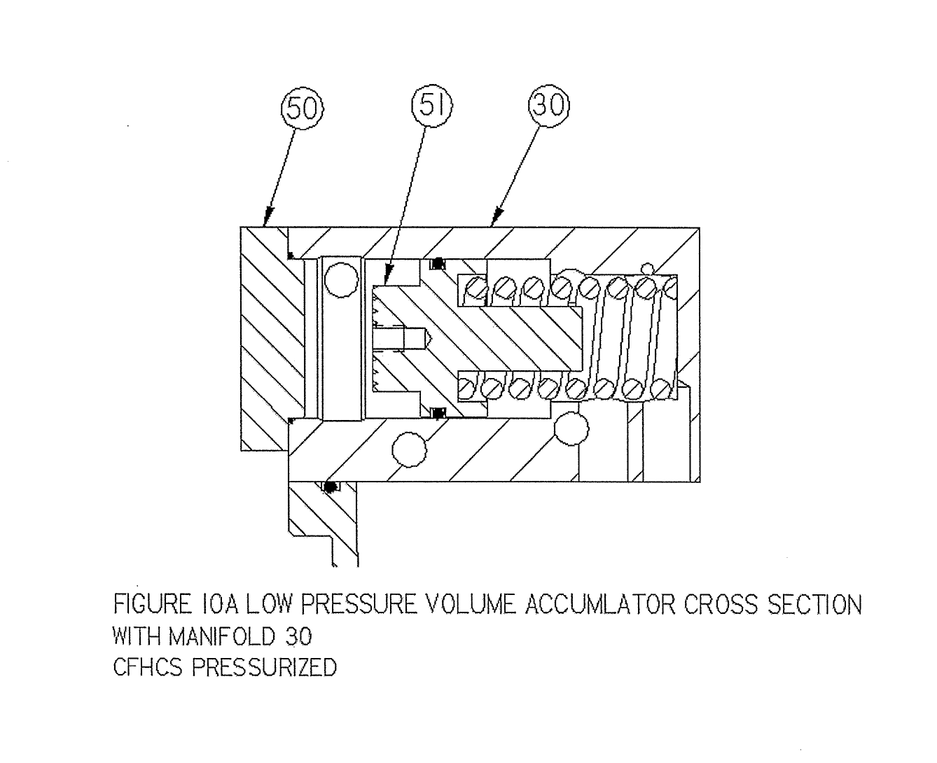

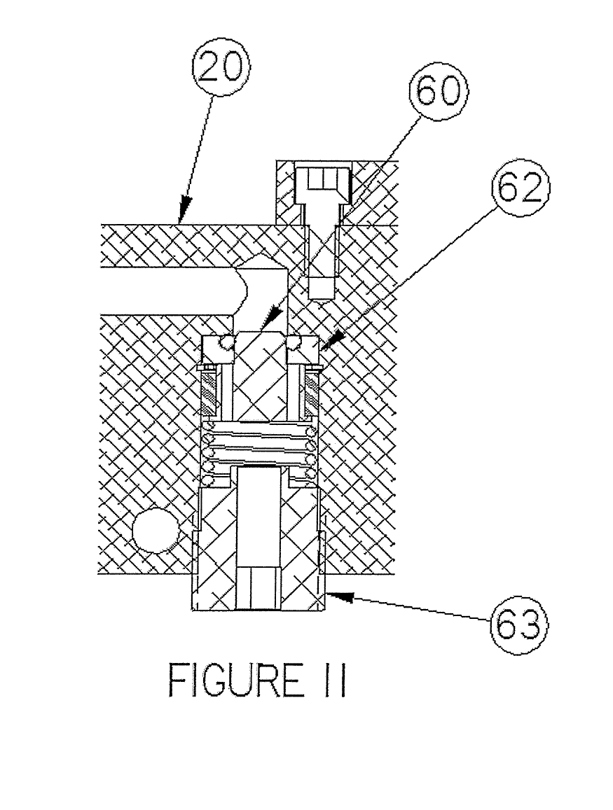

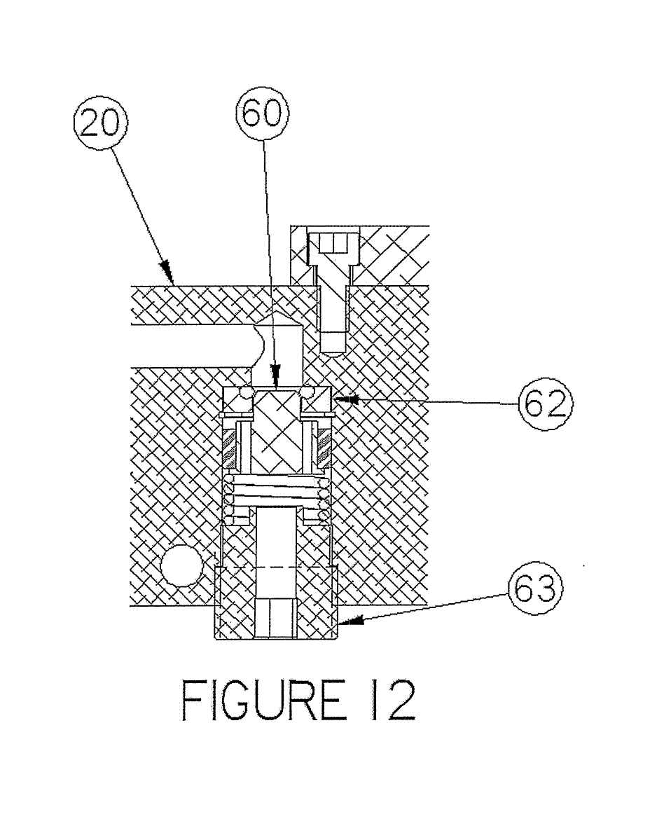

Referring to FIGS. 11 and 12, the low pressure relief valve 7 is assembled into manifold 20 using three additional proprietary parts. FIG. 11 shows the CFHCS without pressure and poppet 60 engaging the soft seal contained by seat 62. FIG. 11 shows the CFHCS without pressure and poppet 60 disengaged from the soft seal contained by seat 62.

Another embodiment of low pressure relief valve 7 is shown in FIG. 12A. Low pressure relief valve 7 is assembled into manifold 30 using three additional proprietary parts. (Assembly of low pressure relief valve 7 into manifold 31 and 32 occurs in a manner similar to those described in connection with manifold 30.) Poppet 60 cycles in a vertical plane within a matching bore provided in manifold 30. A bushing preferably made of plastic to reduce friction is installed on a matching diameter on poppet 60. A shoulder provided on poppet 60 contacts a chamfer provided on a mating surface on seat 62. Four holes drilled through and normal to a mating surface provided on poppet 60 intersect a chamfer provided on the mating surface of seat 62 to provide a flow path to fully contained reservoir 12.

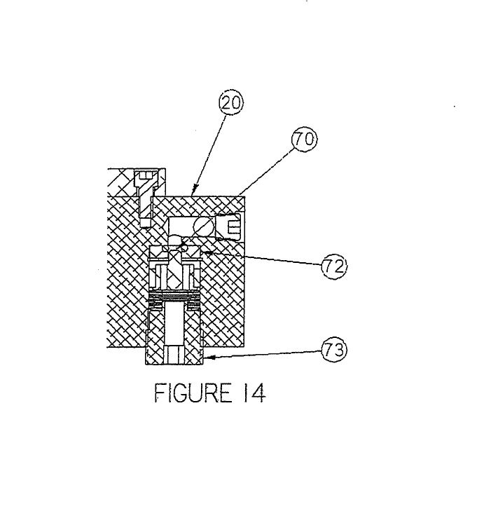

Poppet 60 contains a coil spring load determined by the assembled position of cap 63. Cap 63 threads into manifold 30 against a coil spring installed in a matching bore provided in manifold 30. A hex hole provided in the flat end of cap 63 provides a means to adjust the opposing coil spring load exerted against poppet 60. A lock nut sets the assembled coil spring load and position of cap 63. A hole drilled through cap 63 lets vented fluid to flow into fully contained reservoir 12. Cap 63 is common to the high pressure relief valve 4 shown in FIG. 14A.

A retaining ring holds seat 62 into its assembled position containing a soft seal between a radially profiled groove provided in seat 62 and the mating surface provided in manifold 30. The contained soft seal prevents low pressure fluid from venting into the fully contained reservoir 12. When the poppet 60 force generated by low pressure increases to a point greater than the opposing coil spring load poppet 60 cycles toward cap 63, thereby disengaging the contained soft seal of seat 62 and allowing fluid to vent from the low pressure circuit to fully contained reservoir 12. When low pressure decreases to the point where poppet 60 force is less than the opposing coil spring load poppet 60 cycles away from cap 63 thereby re-engaging the contained soft seal of seat 62 and re-sealing the low pressure circuit from fully contained reservoir 12.

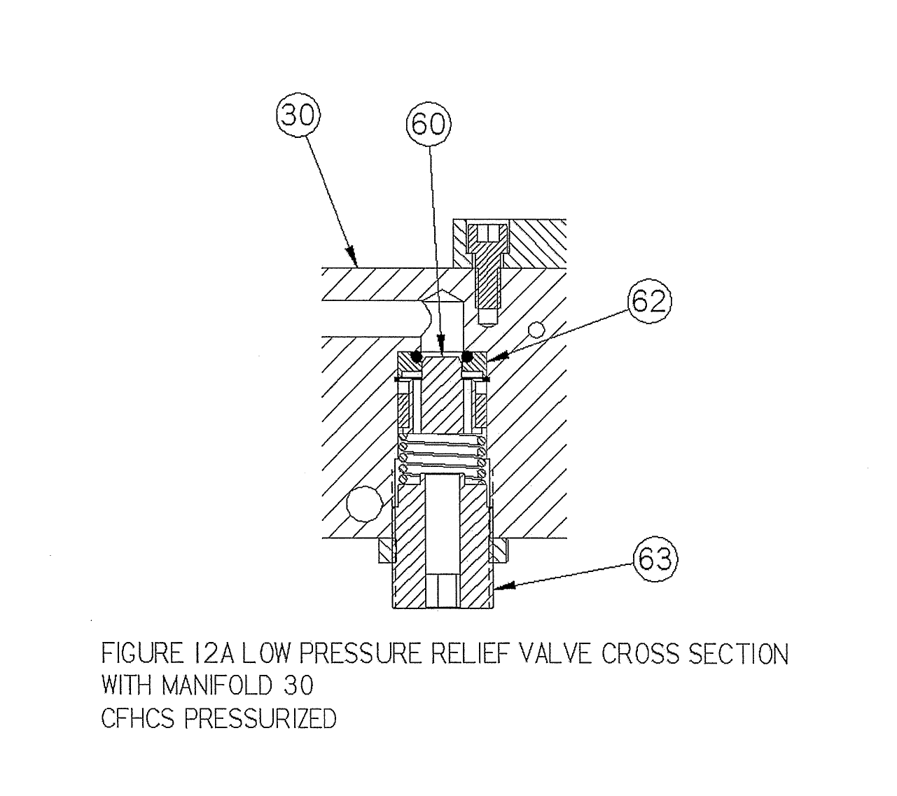

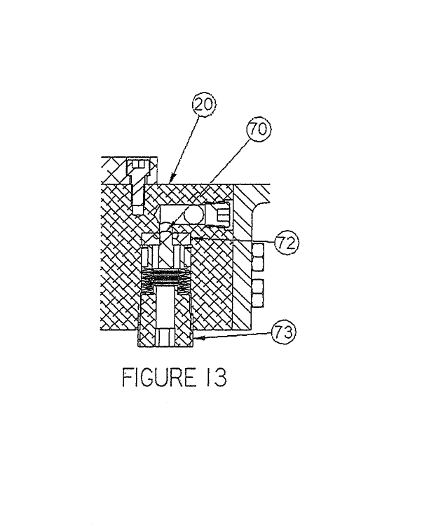

Referring to FIGS. 13 and 14, the high pressure relief valve 4 is assembled into manifold 20 using three additional proprietary parts. FIG. 13 shows the CFHCS without pressure and poppet 70 engaging a soft seal contained by seat 72. FIG. 14 shows the CFHCS without pressure and poppet 70 disengaged from the soft seal contained by seat 72.

Another embodiment of high pressure relief valve 4 is shown in FIG. 14A. High pressure relief valve 4 is assembled into the manifold 30 using three additional proprietary parts. (Assembly of high pressure relief valve 4 into manifold 31 and 32 occurs in a manner similar to those described in connection with manifold 30.) Poppet 70 cycles in a vertical plane within a matching bore provided in manifold 30. A bushing, preferably made of plastic to reduce friction, is installed on a matching diameter on poppet 70. A shoulder provided on poppet 60 contacts a chamfer provided on mating surface on seat 72. Four holes drilled through and normal to the mating surface provided on poppet 70 intersect a chamfer provided on the mating surface of seat 62 to provide a flow path to fully contained reservoir 12.

Poppet 70 contains a Belleville spring stack load determined by the assembled position of cap 63. Cap 63 threads into manifold 30 against a Belleville spring stack installed in a matching bore provided in manifold 30. A hex hole provided in the flat end of cap 63 provides a means to adjust the opposing Belleville spring stack exerted against poppet 70. A lock nut sets the assembled coil spring load and position of cap 63. A hole drilled through cap 73 lets vented fluid into fully contained reservoir 12. Cap 63 is common to the low pressure relief valve 7 shown in FIG. 12A.

A retaining ring holds seat 72 into its assembled position containing a soft seal between a radially profiled groove provided in seat 72 and the mating surface provided in manifold 30. The contained soft seal prevents low pressure fluid from venting into fully contained reservoir 12. When the force on poppet 70 generated by high pressure increases to a point greater than the opposing Belleville spring stack load, poppet 70 cycles toward cap 63, thereby disengaging the contained soft seal of seat 72 and allowing fluid to vent from the high pressure circuit to fully contained reservoir 12. When high pressure decreases to the point where poppet 60 force is less than the opposing Belleville spring stack load poppet 70 cycles away from cap 63 thereby re-engaging the contained soft seal of seat 67 and re-sealing the high pressure circuit from fully contained reservoir 12.

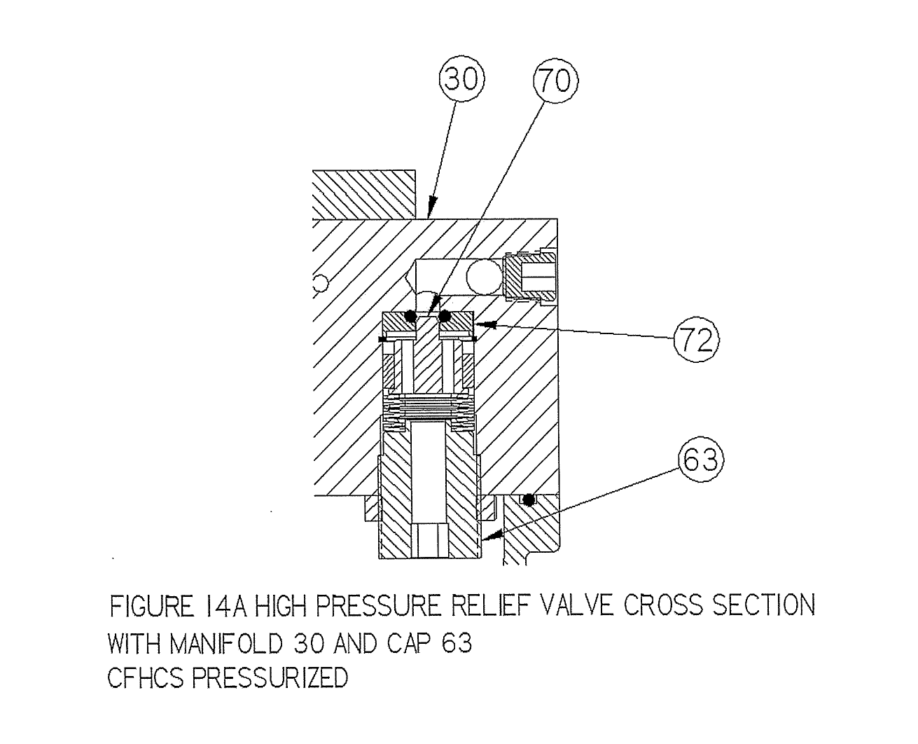

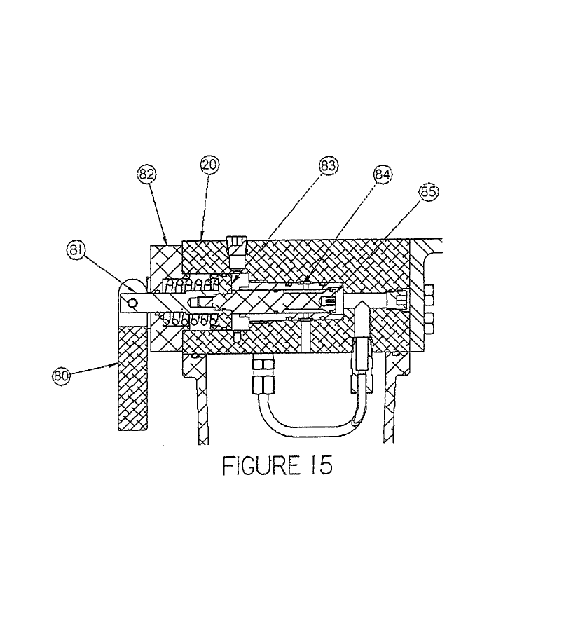

Referring to FIG. 15, the piloted 2-way dump valve 9 is assembled into manifold 20 using six additional proprietary parts. It is shown in the “dumped” position and configured for switching low pressure.

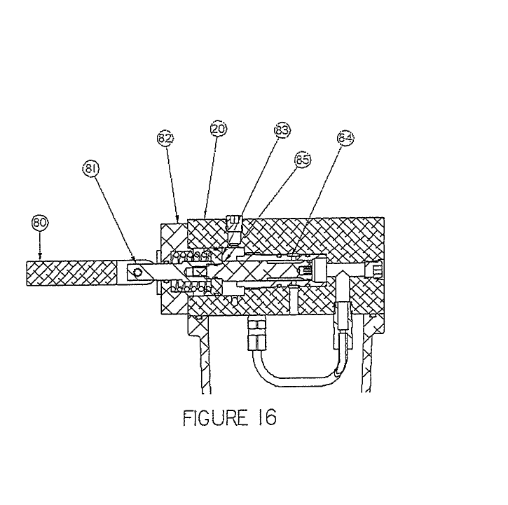

Referring to FIG. 16, the piloted 2-way dump valve 9 is assembled into manifold 20 using six additional proprietary parts. It is shown in the leveled position and configured for switching low pressure.

Referring to FIG. 17, the piloted 2-way dump valve 9 is assembled into manifold 20 using six additional proprietary parts. It is shown in the charged position and configured for switching low pressure.

Referring to FIG. 17A, another embodiment of piloted 2-way dump valve 9, switching low pressure, is shown in its normal operating or charged position. This embodiment of piloted 2-way dump valve 9 is assembled into manifold 30 using eight additional proprietary parts. (Assembly of piloted 2-way dump valve 9, switching low pressure, into manifold 32 occurs in a manner similar to those described in connection with manifold 30.) Low pressure Plunger 88 cycles axially in the horizontal plane within a bore provided in low pressure sleeve 89 which is assembled in a matching bore provided in manifold 30. Low pressure Sleeve 89 and lever guide 86 are preferably plastic to reduce friction.

A retaining ring maintains low pressure sleeve 89 in the assembled position against a matching face provided in manifold 30. A soft seal contained on the end of low pressure plunger 88 engages the bore of sleeve 89, thereby sealing the low pressure circuit from fully contained reservoir 12. The soft seal on the end of low pressure plunger 88 is installed within a dove tail groove, and thereby contained in the groove as low pressure fluid flows across it when the piloted 2-way dump valve 9 is opened. When the soft seal on the end of low pressure plunger 88 no longer engages the bore of low pressure sleeve 89, cross drilled annular grooves provided on the outside and inside diameters of low pressure sleeve 89 create a flow passage for low pressure fluid to vent into fully contained reservoir 12 when the piloted 2-way dump valve 9 is opened.

Low pressure plunger 88 is assembled together as a unit with piston 83 and lift 81. Low pressure plunger 88 threads into lift 81, and piston 83 is thereby fixed in position between low pressure plunger 88 and lift 81. Piston 83 cycles in a matching bore provided in manifold 30. Cover 82 is bolted and sealed against manifold 30 and provides a matching bore for lift 81 to cycle axially within in a horizontal plane. The cover 82 contains the coil spring load, as set by the assembled position of cover 82, which is exerted against piston 83. The low pressure force acting on piston 83 is balanced against the coil spring force exerted on piston 83.

In the charged position, lever 80 is hanging vertically, supported by lift 81 and a cap screw installed through matching clearance holes provided in lift 81 and lever 80. One end of lever spring 87 is fixed to the end face provided on lift 81 with a machine screw and flat washer. Lever spring 87 is unloaded and installed within a slot provided in lever 80 and contained radially at the other end by a spring pin assembled in a through hole provided in lever 80. Lever guide 86 is assembled against cover 82 with machine screws and prevents lever 80 from rotating about the center of piloted 2-way dump valve 9 and also beyond the leveled position shown in FIG. 16.

Piloted 2-way dump valve 9 is opened either by venting low circuit pressure which acts on piston 83 or by manually pushing on lever 80 with an axial force greater than the combined net force acting on piston 83 by low pressure and the opposing coil spring load. When the low pressure circuit is vented, the low pressure force acting on piston 83 is less than the opposing coil spring load. This results in low pressure plunger 88 cycling axially in low pressure sleeve 89 away from cover 82, thereby disengaging the soft seal contained on the end of low pressure plunger 88 from the bore of low pressure sleeve 89. The resulting movement of low pressure plunger 88 coincidentally results in lever 80 cycling to the dumped position.

When lever 80 is manually pushed, low pressure plunger 88 cycles axially in the bore of low pressure sleeve 89 and away from cover 82, thereby disengaging the soft seal contained on the end of low pressure plunger 88 from the bore of low pressure sleeve 89. When lever 80 is manually pushed additional low pressure fluid flows into low pressure volume accumulator 8, further cycling piston 51, creating a temporary and insignificant increase in low circuit pressure.

Before the CFSHC can be reset or re-charged and the fail-safe valve returned to its normal operating position, lever 80 is manually rotated up to the leveled position shown in FIG. 16. In the leveled position, torsion load contained radially by a spring pin assembled in a through hole provided in lever 80 is exerted by lever spring 87 on lever 80. This torsion load would rotate lever 80 back down to the vertical dumped position without the assembled coil spring load acting on piston 83. Hand pump 1 or oil immersed electric pump 13 can subsequently be utilized to reset, or recharge, the CFSHC and re-position the pipeline valve into its normal operating position, either fully open or fully closed. When the CFSHC is fully reset, or fully re-charged, lever 80 automatically drops down to the vertical charged position, and the pipeline valve is fully open or closed.

If pipeline pressure is not within the normal operating range as determined by the set points of 3-way high and low pressure pilot, and the 3-way electric solenoid valve 11 is not energized, the CFSHC can not be reset or re-charged. However, in this scenario, for inherent safety the fail-safe valve can be returned to its normal operating position albeit without lever 80 automatically dropping down to the vertical charged position.

Referring to FIG. 18, piloted 2-way dump valve 9 is assembled into manifold 20 using seven additional proprietary parts. It is shown in the dumped position and configured for switching high pressure. Manifold 20 is modified by the addition of porting to connect piloted 2-way dump valve 9, switching high pressure, to the other control components.

Referring to FIG. 18A another embodiment of piloted 2-way dump valve 9, switching high pressure, is shown in cross section in its normal operating position, or charged position. This embodiment of piloted 2-way dump valve 9 is assembled into manifold 31 using nine additional proprietary parts. High pressure plunger 92 is cycled axially in the horizontal plane within a bore provided by high pressure seat 91, which is assembled in a matching bore provided in manifold 31. High pressure seat 91, high pressure sleeve 90, and lever guide 86 are preferably plastic to reduce friction.

High pressure seat 91 is maintained in the assembled position and contains a Belleville spring stack force as determined by the assembled position of high pressure sleeve 90. High pressure sleeve 90 threads into manifold 31 and is adjusted to set the assembled Belleville stack spring load which is exerted on high pressure seat 91. An enlarged tapered surface provided at the end of high pressure plunger 92 engages a seal edge provided in the bore of high pressure seat 91, thereby sealing high pressure from the fully contained reservoir 12. High pressure seat 91 is provided with four equally spaced slots, over which the Belleville spring stack is assembled, to create a flow passage for high pressure fluid to vent into fully contained reservoir 12 when the piloted 2-way dump valve 9 is opened.

High pressure plunger 92 is assembled together as a unit piston 83 and lift 81. High pressure plunger 92 threads into lift 81, and piston 83 is thereby fixed in position between high pressure plunger 88 and lift 81. Piston 83 cycles in a matching bore provided in manifold 31. Cover 82 is bolted and sealed against manifold 31 and provides a matching bore for lift 81 to cycle axially within in the horizontal plane. The cover 82 contains the coil spring load, as set by the assembled position of cover 82, which is exerted against piston 83. The low pressure force acting on piston 83 is balanced against the coil spring force exerted on piston 83. Operation of piloted 2-way dump valve 9, switching high pressure, in manifold 31 occurs in a manner similar to those described in connection with piloted 2-way dump valve 9, switching low pressure, shown in FIG. 17A.

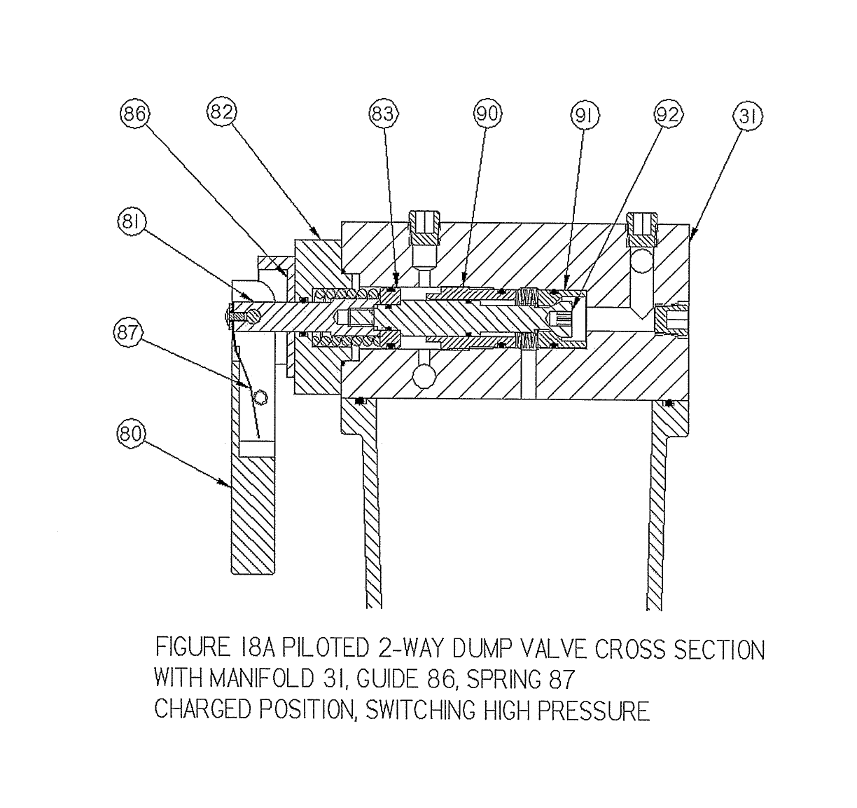

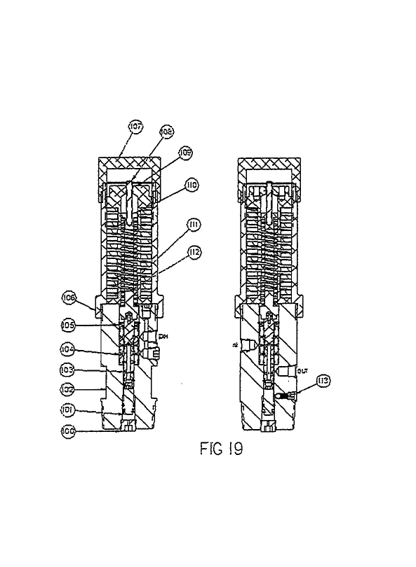

Referring to FIG. 19, 3-way high and low pressure pilot 10, with 0.562″ diameter piston 101, is assembled using fourteen proprietary parts including body 102, spool 103, spring nut 109, piston orifice 100, low spring plate 110, high spring saddle 111 and vent orifice 113.

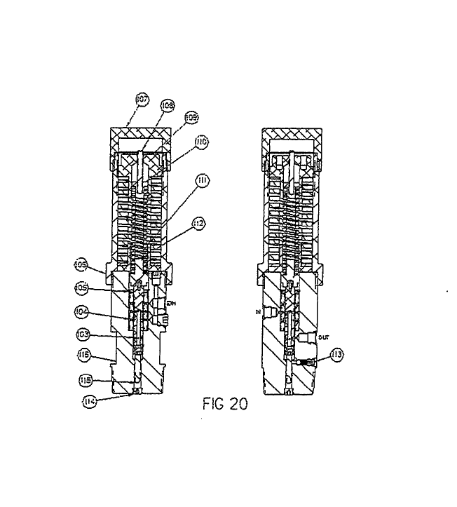

Referring to FIG. 20, 3-way high and low pressure pilot 10, with 0.312″ diameter piston 115, is assembled using fourteen proprietary parts including body 116, spool 103, spring nut 109, piston orifice 114, low spring plate 110, high spring saddle 111 and vent orifice 113.

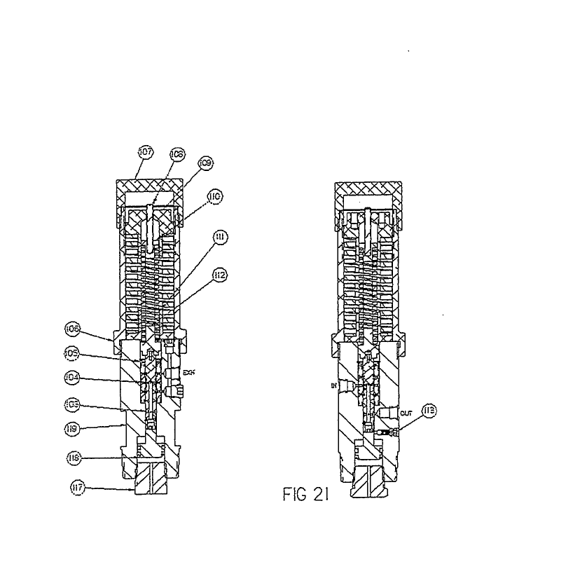

Referring to FIG. 21, 3-way high and low pressure pilot 10, with 1.125″ diameter piston 118, is assembled using fourteen proprietary parts including body 119, spool 103, spring nut 109, piston orifice 117, low spring plate 110, high spring saddle 111 and vent orifice 113.

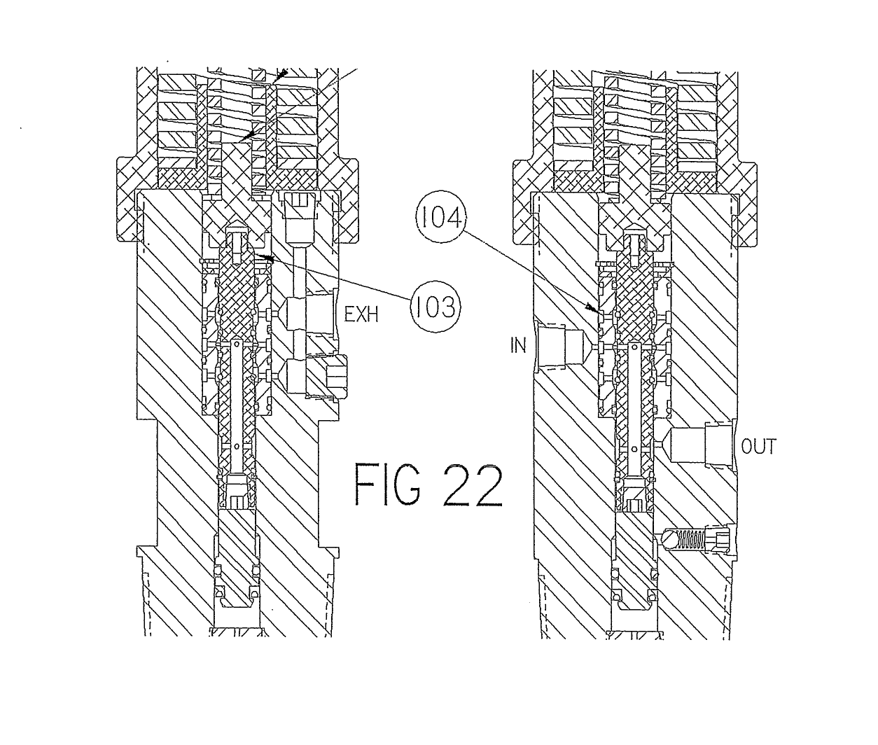

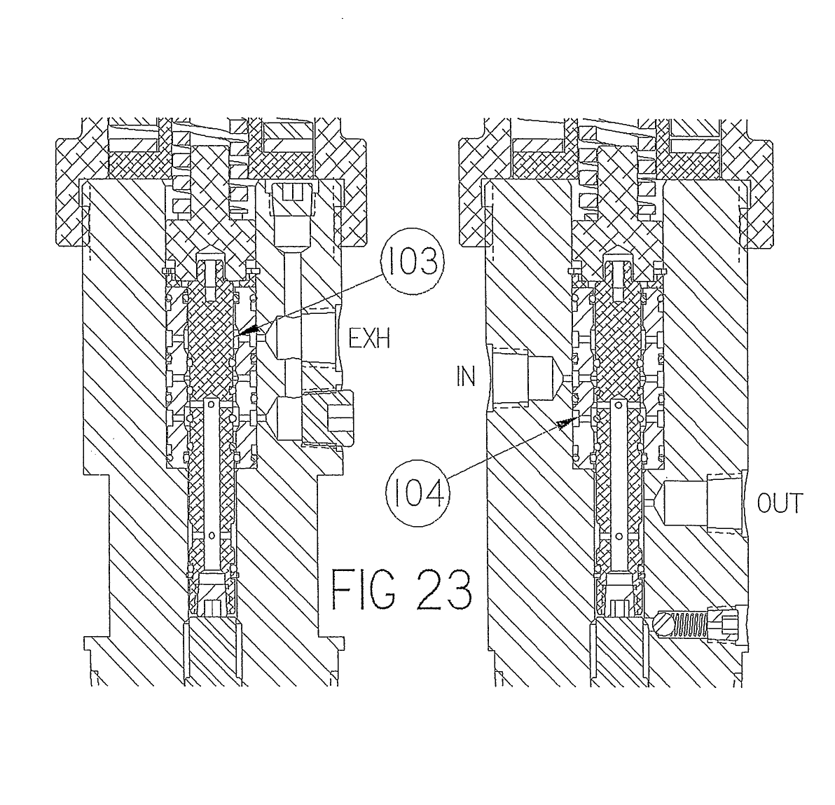

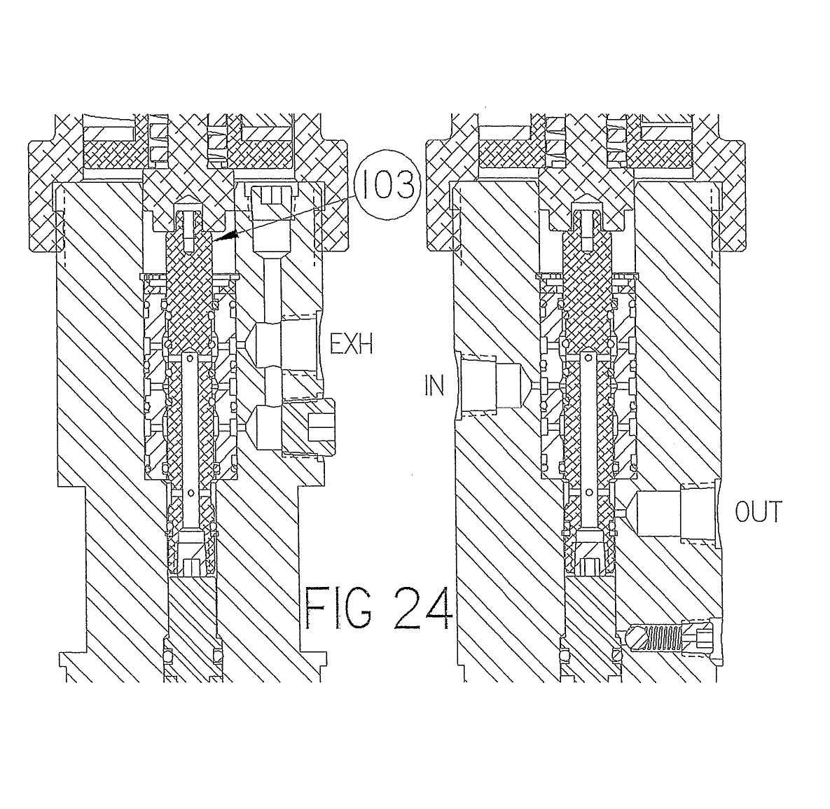

FIG. 22 illustrates 3-way high and low pressure pilot 10 with the seals of spool 103 centered in sleeve 104 with normal pipeline pressure. With low pipeline pressure, spool 103 moves vertically downward to the position shown in FIG. 23. With high pipeline pressure, spool 103 moves vertically upward to the position shown in FIG. 24.

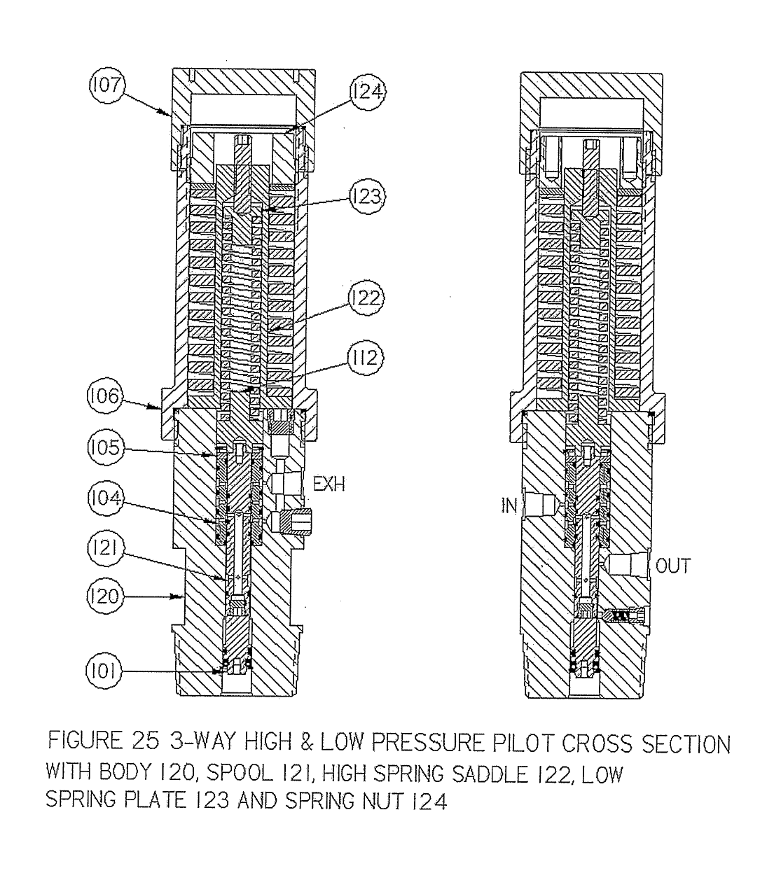

Referring to FIG. 25, an alternate embodiment of 3-way high and low pressure pilot 10, assembled using eleven proprietary parts is shown. Piston 101 cycles axially in a matching bore provided in body 120. Spool 121 cycles axially in a matching bore provided in sleeve 104 which, in turn, is positioned in a matching bore provided in body 120. Sleeve 104 and high spring washer are preferably plastic to reduce friction. Piston 101 is contained within the bore provided in body 120 with a retaining ring. The top end of piston 101 contacts the hex socket plug of spool 121, thereby transferring piston force generated by pipeline pressure. Sleeve 104 is maintained in the assembled position with sleeve ring 105 and a retaining ring against a matching face provided in body 120. The top end of spool 121 contacts low spring saddle 112. Low spring saddle 112 and sleeve 104 are positioned in a common matching bore provided in body 120.

Low spring saddle 112 and low spring are assembled in position on top of spool 121. High spring saddle 122 and high spring are assembled in position over the low spring and low spring saddle 112. High spring saddle 122 is axially positioned by the top face provided on body 120. Spring canister 106 threads onto body 120 against a shoulder and seal, and provides a matching bore for the high spring. The high spring washer and low spring plate 123 are assembled in position on top of the high spring and low spring. High spring nut 124 is threaded into spring canister 106. The assembled position of the high spring nut 124 compresses and sets the high spring assembled load. The set screw threads into the top of the high spring saddle 122 and contacts low spring plate 123 which provides a matching bore for the set screw. The assembled position of the set screw compresses and sets the low spring assembled load. Spring cap 107 threads onto spring canister 106 against a shoulder and seal provided. Body 120 is threaded into the pipeline utilizing two flat surfaces provided on the body 120.

Pipeline pressure generates a force on piston 101 that is transferred to the low spring and low spring saddle 112 by spool 121. As pipeline pressure increases, the force acting on piston 101 increases and low spring saddle 112 cycles axially toward high spring saddle 122 and makes contact. Maximum low spring compression occurs when the low spring saddle 112 contacts the high spring saddle 122. Pipeline pressure will increase to the point where low spring saddle 112 transfers the force acting on piston 101 to high spring saddle 122, thereby lifting high spring saddle 122 off and away from the top of body 120 further compressing the high spring. With increasing pipeline pressure, axial movement of piston 101 is limited by the opposing shoulder provided in the body 120.

As pipeline pressure decreases, the force acting on piston 101 decreases and the low spring saddle 112 cycles axially away from high spring saddle 122. With decreasing pipeline pressure axial movement of piston 101 is limited by the axial movement of the low spring saddle. When pipeline pressure decreases, low spring saddle 112 cycles axially away from high spring saddle 122 until contact with the top face provided on sleeve ring 105 is made. Minimum high spring compression occurs when the high spring saddle 122 re-contacts the top face provided on body 120.

As spool 121 cycles axially with increasing and decreasing pipeline pressure, the four substantially equally spaced soft seals contained on spool 121 engage and disengage specifically spaced matching bores provided in sleeve 104. The matching bores of sleeve 104 are specifically spaced relative to the soft seals contained on spool 121. The specific spacing of the matching bores provided in sleeve 104 creates flow passages, which are either open or closed, depending on the axial position of spool 121 relative to sleeve 104. The four substantially equally spaced soft seals of spool 121 are assembled into dove tail grooves, and are thereby contained within their grooves as low pressure fluid flows across them when the created flow passages are opened.

In the normal operating position of 3-way high and low pressure pilot 10, low pressure fluid flows into body 120 at the IN port, into the spool 121 at the end with the pipe plug installed, out the spool 121 near it's middle, and out of body 120 at the OUT port. This flow passage is created by the cross-drilled holes in body 120, the three cross drilled inner and outer annular cavities of sleeve 104, the four substantially equally spaced soft seals contained on spool 121 and the cross drilled hole pattern provided in spool 121.

With low pipeline pressure, the axial position of the four substantially equally spaced soft seals contained on spool 121, relative to the specifically spaced matching bores of sleeve 104 results in an effective seal between low pressure fluid at the IN port and both the OUT port and EXH port of body 102. Low pipeline pressure also results in the creation of a flow passage, similar to the flow passage described above, opening between the OUT port and the EXH port of body 120.

With high pipeline pressure, the axial position of the four substantially equally spaced soft seals contained on spool 121, relative to the specifically spaced matching bores of sleeve 104 results in an effective seal between low pressure fluid at the IN port and both the OUT and EXH port of body 120. High pipeline pressure also results in the creation of a flow passage, similar to the flow passage described above, opening between the OUT port and the EXH port of body 120.

The increasing and decreasing pressure scenarios result in low pressure fluid venting to fully contained reservoir 12 through 3-way high and low pressure pilot 10 and the open piloted 2-way dump valve 9. The pipeline valve subsequently cycles to its fail-safe position, fully closed or fully open.

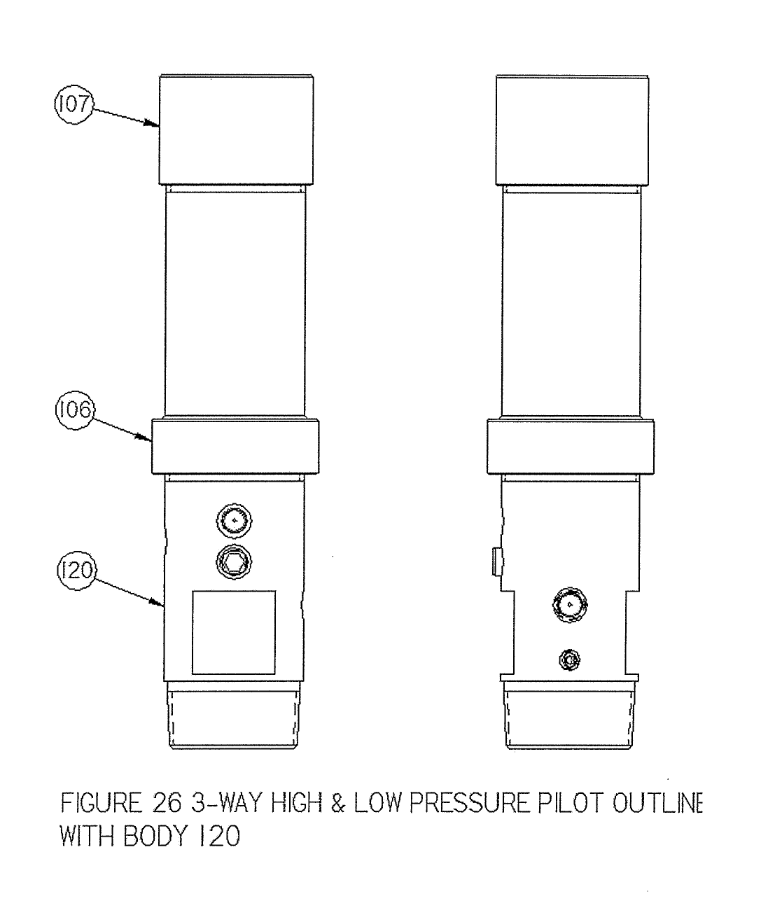

Referring to FIG. 26, all of the various embodiments of 3-way high and low pressure pilot 10 fit within the same outline as assembled with body 120. Additionally, various piston diameters are provided within the same outline shown.

The foregoing description details certain preferred embodiments of the present invention and describes the best mode contemplated. It will be appreciated, however, that changes may be made in the details of construction and the configuration of components without departing from the spirit and scope of the disclosure. Therefore, the description provided herein is to be considered exemplary, rather than limiting, and the true scope of the invention is that defined by the following claims and the full range of equivalency to which each element thereof is entitled.

What is claimed is:

1. A manifolded fail-safe hydraulic control system for controlling fail-safe operation of a pipeline valve, said control system comprising:
a pump;
a pressure regulator;
a low pressure volume accumulator;
a low pressure relief valve;
a high pressure relief valve;
a piloted 2-way dump valve;
a reservoir;
and a manifold,
said manifold having passageways capable of allowing fluid flow within said passageways; said pump, said low pressure volume accumulator, said pressure regulator;
said low pressure relief valve, said high pressure relief valve and said piloted 2-way dump valve each being containable within one of said manifold and said reservoir and being connectable to said passageways in said manifold.

2. A manifolded fail-safe hydraulic control system according to claim 1, an outer perimeter of said reservoir being fully containable within an outer perimeter of said manifold.

3. A manifolded fail-safe hydraulic control system according to claim 1, said control system further comprising a 3-way electric solenoid valve.

4. A manifolded fail-safe hydraulic control system according to claim 1, said pump is a hand pump further comprising a handle and a pump piston, said handle providing a plurality of indexed operating positions in a vertical plane of said hand pump, said pump piston being containable within said manifold and being connectable to said passageways in said manifold.

5. A manifolded fail-safe hydraulic control system according to claim 4, said pump further comprising a module, said module containing a check valve and pump discharge filter, said module being connectable to said manifold and providing access to said check valve and pump discharge filter without affecting containment of said pump piston in said manifold.

6. A manifolded fail-safe hydraulic control system according to claim 1, said pump is an oil immersed electric pump, said electric pump being containable within said reservoir.

7. A manifolded fail-safe hydraulic control system according to claim 1, said piloted 2-way dump valve further comprising a dump valve cover, a lift, a dump valve piston, a dump valve piston spring load, a dump valve sleeve, and a plunger, said lift and said plunger being connectable to one another to fasten said dump valve piston in between.

8. A manifolded fail-safe hydraulic control system according to claim 7, said piloted 2-way dump valve further comprising a lever, said lever having a lever spring load and a lever guide, said lever guide configured to prevent said lever from being moved into a position that could render ineffective said manifolded fail-safe hydraulic circuit.

9. A manifolded fail-safe hydraulic control system according to claim 7, said piloted 2-way dump valve further comprising a dump valve high pressure seat and a dump valve seat spring load, said dump valve sleeve being a high pressure sleeve and threaded.

10. A manifolded fail-safe hydraulic control system according to claim 7, said plunger being a high pressure plunger having an enlarged tapered end to engage said high pressure sleeve.

11. A manifolded fail-safe hydraulic control system according to claim 7, said piloted 2-way dump valve further comprising a retaining ring, said dump valve sleeve being a low pressure sleeve and having a plurality of inner and outer annular cavities, said plurality of inner and outer annular cavities having cross-drilled radially spaced fluid flow passages.

12. A manifolded fail-safe hydraulic control system according to claim 11, said plunger being a low pressure plunger having a plurality of soft seals located on an outside diameter of said low pressure plunger, said plurality of soft seals spaced axially in relation to said radially spaced fluid flow passages.

13. A manifolded fail-safe hydraulic control system according to claim 1, said pressure regulator further comprising a cover, a regulator piston, a spring plate, a regulator piston spring load, a high pressure regulator poppet, and a high pressure regulator poppet spring load, said regulator piston oriented to cycle in a vertical plane of said manifold.

14. A manifolded fail-safe hydraulic control system according to claim 13, said high pressure regulator poppet oriented to provide a high pressure seat surface against said manifold.

15. A manifolded fail-safe hydraulic control system according to claim 1, said low pressure volume accumulator further comprising an accumulator cover, an accumulator piston, and an accumulator piston spring load, said accumulator piston having an extended spring guide diameter.

16. A manifolded fail-safe hydraulic control system according to claim 15, said accumulator piston further comprising at least one spiral groove across a face of said piston.

17. A manifolded fail-safe hydraulic control system according to claim 1, said low pressure relief valve and said high pressure relief valve each having a shared cap and each further comprising a valve poppet, a valve seat, and a valve poppet spring load, said valve poppet oriented to cycle in a vertical plane of said manifold, said valve seat oriented to form a soft seal.

18. A manifolded fail-safe hydraulic control system according to claim 1, said control system further comprising a 3-way high and low pressure pilot.

19. A manifolded fail-safe hydraulic control system according to claim 18, said 3-way high and low pressure pilot further comprising a pilot sleeve and a pilot retaining ring, said pilot sleeve having a plurality of inner and outer annular cavities, said plurality of inner and outer annular cavities having cross-drilled radially spaced fluid flow passages.

20. A manifolded fail-safe hydraulic control system according to claim 19, said pilot sleeve further comprising a pilot spool, said pilot spool having a plurality of outer soft seals, said outer soft seals specifically spaced axially in relation to said radially spaced fluid flow passages in said pilot sleeve.

21. A manifolded fail-safe hydraulic control system according to claim 18, said 3-way high and low pressure pilot further comprising a pilot low spring saddle, a pilot low spring plate, a pilot high spring saddle, a pilot spring nut, a pilot low spring load, and a pilot high spring load, said pilot high spring saddle oriented to encompass and limit compression of said pilot low spring at a high pipeline pressure.

22. A manifolded fail-safe hydraulic control system according to claim 21, said pilot spring nut further comprising a hole through which said pilot high spring saddle moves axially, said pilot high spring saddle oriented to encompass and limit de-compression of said pilot high spring at a low pipeline pressure.

23. A method of hydraulic control of a pipeline valve comprising the steps of:
holding hydraulic fluid pressure in an actuator hydraulic cylinder that maintains a valve in its normal operating position; and
venting hydraulic fluid pressure from the actuator hydraulic cylinder in order to allow the valve to move into its fail-safe position.

24. The method of claim 23, said venting step further comprising the steps of:
removing the monitored pipeline parameter signal to the piloted two-way dump valve; and
releasing the spring load on a piston of the piloted two-way dump valve so that the two-way dump valve is in its open position.

25. The method of claim 23, said holding step further comprising the steps of:
positioning a lever of a two-way dump valve under spring load so that the two-way dump valve is in its closed position; and
conditioning a monitored pipeline parameter signal to the piloted two-way dump valve; and
activating the lever to swing vertically downward to indicate when the pipeline valve is correctly reset.

26. The method of 25, said conditioning step further comprising the steps of:
placing a pressure-responsive spool inside a sleeve of a pilot so that the spool is free to move axially within the sleeve based on a monitored pipeline parameter signal;
limiting the lower axial movement of the spool within the sleeve based on a low pipeline parameter signal;
limiting the higher axial movement of the spool within the sleeve based on a high pipeline parameter signal;
setting seal positions within the sleeve for holding hydraulic fluid pressure at a normal pipeline parameter signal; and
setting seal positions within the sleeve for venting hydraulic fluid pressure at a high or a low pipeline parameter signal.
